(19) United States
(12) Patent Application Publication
(10) Pub. No.: US 2025/0244513 A1
(43) Pub. Date: Jul. 31, 2025

(54) Heads-Up Display And Coating Therefor

(71) Applicant: Vitro Flat Glass LLC, Cheswick, PA (US)

(72) Inventors: Alexandra Gordienko, Natrona Heights, PA (US); Paul A. Medwick, Wexford, PA (US); Andrew V. Wagner, Pittsburgh, PA (US)

(21) Appl. No.: 19/039,355

(22) Filed: Jan. 28, 2025

Related U.S. Application Data
(60) Provisional application No. 63/626,711, filed on Jan. 30, 2024.

(51) Int. Cl. G02B 5/30; G02B 27/01

(52) U.S. Cl. CPC G02B 5/3066; G02B 27/0101

(57) ABSTRACT

The present invention relates to a laminate having enhanced p-polarized radiation reflecting properties, and, in some embodiments, to a display system for projecting an image and a method of projecting an image onto a heads-up display.

### RELATED APPLICATION DATA

The present application claims priority to, and is a non-provisional of, U.S. Provisional Patent Application No. 63/626,711, filed Jan. 30, 2024, the disclosure of which is hereby incorporated by reference in its entirety.

### BACKGROUND OF THE INVENTION

### Field of the Invention

The present invention relates to a laminate having enhanced p-polarized radiation reflecting properties, and, in some embodiments, to a display system for projecting an image and a method of projecting an image onto a heads-up display.

### Description of Related Art

Conventional automotive heads-up displays (HUDs) use an electromagnetic radiation source in the dashboard that projects light up onto the windshield, which is then reflected to the driver's eyes, creating a virtual image of vehicle data so that the driver has access to information about the vehicle's operation without having to look away from the road. For electromagnetic radiation reflecting off of the windshield at angles typically found in a conventional vehicle, the reflected light primarily is s-polarized, with a much smaller component of the light being p-polarized. In the extreme case, if the angle of incidence of the electromagnetic radiation to the windshield is the Brewster's angle of an air to glass interface (approximately 57 degrees), the p-polarized reflectance is zero percent.

Light from the radiation source (primarily s-polarized) will reflect at least off of both the innermost surface of the windshield and the outermost surface of the windshield due to the index mismatch between air and glass. This leads to at least two reflected images being formed, one from each surface. Multiple images formed in a HUD is a phenomenon referred to as “ghosting”, and eliminating or minimizing the presence of “ghosts” is a goal of HUD technology. A conventional method of resolving ghosting is by employing a wedge-shaped vinyl layer between the inner and outer glass plies of the windshield to adjust the geometry of the two glass plies to align the two reflected images. This wedge-shaped vinyl increases the cost of the windshield and also increases the complexity of manufacturing the windshield.

It is also desirable to apply a coating to at least one of the glass plies to provide solar control, heating, and/or antenna functionality to the windshield. This additional coating leads to a third index mismatch within the windshield, which leads to a third reflection, and a third reflected image on the HUD system, which is difficult to be compensated for by the wedge-shaped vinyl layer.

Another problem with conventional HUD systems results from the fact that many drivers wear polarized sunglasses to reduce glare from the road and other sources while driving. Typical polarized sunglasses work by blocking s-polarized radiation. P-polarized radiation is able to pass through the polarized sunglasses. However, as mentioned above, in conventional HUD systems, s-polarized radiation is primarily what reflects off of the windshield to form the image of the HUD, and very little p-polarized radiation is reflected off of the windshield surfaces. This is especially true considering the windshield is typically positioned at an angle near the Brewster's angle for the air to glass interface. Thus, a driver wearing conventional polarized sunglasses may not be able to see the image of the HUD formed by the primarily s-polarized radiation.

Therefore, there is a need in the art for a system and/or components to reduce or eliminate one or more of these problems. For example, it would be desirable to provide a HUD system that projects an image viewable to drivers wearing polarized sunglasses and/or that reduces or eliminates ghosting.

### SUMMARY OF THE INVENTION

The present invention relates to a laminate having enhanced p-polarized radiation reflecting properties, and, in some embodiments, to a display system for projecting an image and a method of projecting an image onto a heads-up display.

In one embodiment, the present invention is directed to a laminate, such as a windshield, having enhanced p-polarized radiation reflecting properties. In one embodiment, the laminate includes a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and a first coating positioned over at least a portion of the fourth surface, wherein the first coating comprises a first low refractive index layer positioned over at least a portion of the fourth surface of the second ply; a first medium refractive index layer positioned over at least a portion of the first low refractive index layer; a second low refractive index layer positioned over at least a portion of the first medium refractive index layer; and a first high refractive index layer positioned over at least a portion of the first high refractive index layer, wherein the laminate has a p-polarized reflection, as determined at an angle of 60 degrees relative to the normal of the laminate, of at least 10 percent of the p-polarized radiation at one or more wavelengths of at least 450 nm, 530 nm, and/or 620 nm. In still another embodiment, the laminate further comprises a second coating that is positioned over at least a portion of the second surface or the third surface.

Further non-limiting embodiments or aspects are set forth and described in the following clauses.

Clause 1: A laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and a first coating positioned over at least a portion of the fourth surface, wherein the first coating comprises a first low refractive index layer positioned over at least a portion of the fourth surface of the second ply; a first medium refractive index layer positioned over at least a portion of the first low refractive index layer; a second low refractive index layer positioned over at least a portion of the first medium refractive index layer; and a first high refractive index layer positioned over at least a portion of the second low refractive index layer, wherein the laminate has a p-polarized reflection, as determined at an angle of 60 degrees relative to the normal of the laminate, of at least 10 percent of the p-polarized radiation at one or more wavelengths of at least 450 nm, 530 nm, and/or 620 nm.

Clause 2: The laminate of clause 1, wherein the laminate further comprises a second coating positioned over at least a portion of the second surface or the third surface, and wherein the second coating comprises a first dielectric layer positioned over the portion of the at least one of the second surface and/or the third surface; a first metal layer positioned over at least a portion of the first dielectric layer; a first primer layer positioned over at least a portion of the first metal functional layer; a second dielectric layer positioned over at least a portion of the first primer layer; a second metal layer positioned over at least a portion of the second dielectric layer; a second primer layer positioned over at least a portion of the second metal functional layer; and a third dielectric layer positioned over at least a portion of the second primer layer.

Clause 3: The laminate of any of clauses 1 or 2, wherein the first coating further comprises a second medium refractive index layer positioned between at least a portion of the fourth surface of the second ply and the first low refractive index layer.

Clause 4: The laminate of any of clauses 1-3, wherein the first coating further comprises a protective layer over at least a portion of the first high refractive index layer.

Clause 5: The laminate of clause 4, wherein the protective layer comprises titania, silica-alumina, zirconia, alloys thereof, mixtures thereof or combinations thereof.

Clause 6: The laminate of clause 3, wherein the first coating further comprises a third low refractive index layer positioned over at least a portion of the first high refractive index layer.

Clause 7: The laminate of clause 3, wherein the first coating further comprises either a third medium refractive index layer positioned over at least a portion of the third low refractive index layer or a second high refractive index layer positioned over at least a portion of the third low refractive index layer.

Clause 8: The laminate of clause 7, wherein the first coating further comprises a protective layer over at least a portion of the third medium refractive index or a protective layer over at least a portion of the second high refractive index.

Clause 9: The laminate of clause 8, wherein the either protective layer individually comprises titania, silica-alumina, zirconia, alloys thereof, mixtures thereof or combinations thereof.

Clause 10: The laminate of clause 6, wherein the first low refractive index layer, the second low refractive layer and/or the third low refractive layer individually comprises silica, alumina, or silica-alumina.

Clause 11: The laminate of clause 7, wherein the first medium refractive index layer, the second medium refractive layer, and/or the third medium refractive index layer individually comprises zinc oxide, zinc-tin oxide, or silicon nitride.

Clause 12: The laminate of clause 7, wherein the first high refractive index layer and/or the second high refractive index layer individually comprises metallic silicon, elemental silicon, titania, zirconia, niobium oxide, tantalum oxide, alloys thereof, mixtures thereof, or combinations thereof.

Clause 13: The laminate of clause 6, wherein the first low refractive index layer, the second low refractive layer and/or the third low refractive layer comprise a refractive index of 1.4 to 1.6.

Clause 14: The laminate of clause 7, wherein the first medium refractive index layer, the second medium refractive layer, and/or the third medium refractive index layer individually comprises a refractive index of 1.61 to 1.9.

Clause 15: The laminate of clause 7, wherein the first high refractive index and/or the second high refractive index layer individually comprises a refractive index of 1.91 to 2.2.

Clause 16: The laminate of clause 8, wherein either protective layer individually comprises titania, silica-alumina, zirconia, alloys thereof, mixtures thereof or combinations thereof.

Clause 17: The laminate of any of clauses 1-3, wherein the first coating further comprises a topcoat layer positioned over at least a portion of the first high refractive index layer.

Clause 18: The laminate of clause 7, wherein the first coating further comprises a topcoat layer positioned over at least a portion of the third medium refractive index or a topcoat layer positioned over at least a portion of the second high refractive index.

Clause 19: The laminate of clause 2, wherein the second coating further comprises an overcoat positioned over at least a portion of the third dielectric layer.

Clause 20: The laminate of any of clauses 1-19, wherein the laminate is free from a polyvinyl butyral (PVB) wedge layer.

Clause 21: The laminate of any of clauses 1-20, wherein the first low refractive index layer has a thickness in the range of 200 Å (Angstroms) to 450 Å, the first medium refractive index layer has a thickness in the range of 625 Å to 1025 Å, the second low refractive index layer has a thickness in the range of 1350 Å to 1850 Å, and the first high refractive index layer has a thickness in the range of 400 Å to 700 Å.

Clause 22: The laminate of any of clauses 1-20, wherein the first low refractive index layer has a thickness in the range of 250 Å to 400 Å, the first medium refractive index layer has a thickness in the range of 700 Å to 950 Å, the second low refractive index layer has a thickness in the range of 1450 Å to 1750 Å, and the first high refractive index layer has a thickness in the range of 475 Å to 625 Å.

Clause 23: The laminate of any of clauses 1-20, wherein the first low refractive index layer has a thickness in the range of 275 Å to 375 Å, the first medium refractive index layer has a thickness in the range of 750 Å to 900 Å, the second low refractive index layer has a thickness in the range of 1525 Å to 1675 Å, and the first high refractive index layer has a thickness in the range of 525 Å to 575 Å.

Clause 24: The laminate of clause 3, wherein the second medium refractive index layer has a thickness in the range of 200 Å to 350 Å.

Clause 25: The laminate of clause 3, wherein the second medium refractive index layer has a thickness in the range of 225 Å to 325 Å.

Clause 26: The laminate of clause 7, wherein either the third medium refractive index layer or the second high refractive index layer has a thickness in the range of 10 Å to 200 Å.

Clause 27: The laminate of clause 7, wherein either the third medium refractive index layer or the second high refractive index layer individually has a thickness in the range of 25 Å to 185 Å.

Clause 28: The laminate of clause 2, wherein the first dielectric layer has a thickness in the range of 230 Å to 310 Å, the first metal layer has a thickness in the range of 90 Å to 130 Å, the first primer layer has a thickness in the range of 20 Å to 45 Å, the second dielectric layer has a thickness in the range of 700 Å to 940 Å, the second metal layer has a thickness in the range of 60 Å to 100 Å, the second primer layer has a thickness in the range of 20 Å to 45 Å, and the third dielectric layer has a thickness in the range of 220 Å to 280 Å.

Clause 29: The laminate of clause 2, wherein the first dielectric layer has a thickness in the range of 255 Å to 285 Å, the first metal layer has a thickness in the range of 100 Å to 120 Å, the first primer layer has a thickness in the range of 25 Å to 40 Å, the second dielectric layer has a thickness in the range of 780 Å to 860 Å, the second metal layer has a thickness in the range of 70 Å to 90 Å, the second primer layer has a thickness in the range of 25 Å to 40 Å, and the third dielectric layer has a thickness in the range of 240 Å to 260 Å.

Clause 30: The laminate of any of clauses 1-29, wherein the laminate has a p-polarized reflection, as determined at an angle of 60 degrees relative to the normal of the laminate, of at least 12.5 percent of the p-polarized radiation.

Clause 31: The laminate of any of clauses 1-29, wherein the laminate has a p-polarized reflection, as determined at an angle of 60 degrees relative to the normal of the laminate, of at least 15 percent of the p-polarized radiation.

Clause 32: The laminate of any of clauses 1-31, wherein the laminate has an unpolarized light reflection, as determined at an angle of 60 degrees relative to the normal of the laminate, of less than 30 percent of the unpolarized light.

Clause 33: The laminate of any of clauses 1-31, wherein the laminate has an unpolarized light reflection, as determined at an angle of 60 degrees relative to the normal of the laminate, of less than 25 percent of the unpolarized light.

Clause 34: The laminate of any of clauses 1-31, wherein the laminate has an unpolarized light reflection, as determined at an angle of 60 degrees relative to the normal of the laminate, of less than 22.5 percent of the unpolarized light.

Clause 35: The laminate of any of clauses 1-34, wherein the unpolarized light reflected off the laminate has an a* in the range of −12 to 10, as determined at an angle of 60 degrees relative to the normal of the laminate.

Clause 36: The laminate of any of clauses 1-34, wherein the unpolarized light reflected off the laminate has an a* in the range of −11 to 9, as determined at an angle of 60 degrees relative to the normal of the laminate.

Clause 37: The laminate of any of clauses 1-34, wherein the unpolarized light reflected off the laminate has an a* in the range of −10 to 8, as determined at an angle of 60 degrees relative to the normal of the laminate.

Clause 38: The laminate of any of clauses 1-37, wherein the unpolarized light reflected off the laminate has a b* in the range of −12 to 0, as determined at an angle of 60 degrees relative to the normal of the laminate.

Clause 39: The laminate of any of clauses 1-37, wherein the unpolarized light reflected off the laminate has a b* in the range of −11 to −2, as determined at an angle of 60 degrees relative to the normal of the laminate.

Clause 40: The laminate of any of clauses 1-37, wherein the unpolarized light reflected off the laminate has a b* in the range of −10 to −3, as determined at an angle of 60 degrees relative to the normal of the laminate.

Clause 41: The laminate of any of clauses 1-40, wherein the p-polarized light reflected off the laminate has an a* in the range of −10 to 0, as determined at an angle of 60 degrees relative to the normal of the laminate.

Clause 42: The laminate of any of clauses 1-40, wherein the p-polarized light reflected off the laminate has an a* in the range of −7 to −1, as determined at an angle of 60 degrees relative to the normal of the laminate.

Clause 43: The laminate of any of clauses 1-40, wherein the p-polarized light reflected off the laminate has an a* in the range of −6 to −2, as determined at an angle of 60 degrees relative to the normal of the laminate.

Clause 44: The laminate of any of clauses 1-43, wherein the p-polarized light reflected off the laminate has a b* in the range of 4 to 14, as determined at an angle of 60 degrees relative to the normal of the laminate.

Clause 45: The laminate of any of clauses 1-43, wherein the p-polarized light reflected off the laminate has a b* in the range of 5 to 13, as determined at an angle of 60 degrees relative to the normal of the laminate.

Clause 46: The laminate of any of clauses 1-43, wherein the p-polarized light reflected off the laminate has a b* in the range of 6 to 12, as determined at an angle of 60 degrees relative to the normal of the laminate.

Clause 47: The laminate of any of clauses 1-46, wherein the laminate has an LTA of at least 70 percent.

Clause 48: The laminate of any of clauses 1-46, wherein the laminate has an LTA of at least 74 percent.

Clause 49: The laminate of any of clauses 1-46, wherein the laminate has an LTA of at least 75 percent.

Clause 50: The laminate of any of clauses 1-49, wherein, when the laminate is applied to one side of a glass substrate, the RfY, the percent reflection of visible light from the unlaminated glass side, is within ±1.5 percent of the RfY, the percent reflection of visible light from the laminate side.

Clause 51: A display system for projecting an image comprising a laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and a first coating positioned over at least a portion of the fourth surface, wherein the first coating comprises a first low refractive index layer positioned over at least a portion of the fourth surface of the second ply; a first medium refractive index layer positioned over at least a portion of the first low refractive index layer; a second low refractive index layer positioned over at least a portion of the first medium refractive index layer; and a first high refractive index layer positioned over at least a portion of the second low refractive index layer, wherein the laminate has a p-polarized reflection, as determined at an angle of 60 degrees relative to the normal of the laminate, of at least 10 percent of the p-polarized radiation at one or more wavelengths of at least 450 nm, 530 nm, and/or 620 nm. In still another embodiment, the display system of this clause, or of any one or more of clauses 52-100, can further include at least one suitable radiation source as described herein.

Clause 52: The display system of clause 51, wherein the laminate further comprises a second coating positioned over at least a portion of the second surface or the third surface, and wherein the second coating comprises a first dielectric layer positioned over the portion of the at least one of the second surface and/or the third surface; a first metal layer positioned over at least a portion of the first dielectric layer; a first primer layer positioned over at least a portion of the first metal functional layer; a second dielectric layer positioned over at least a portion of the first primer layer; a second metal layer positioned over at least a portion of the second dielectric layer; a second primer layer positioned over at least a portion of the second metal functional layer; and a third dielectric layer positioned over at least a portion of the second primer layer.

Clause 53: The display system of any of clauses 51 or 52, wherein the first coating further comprises a second medium refractive index layer positioned between at least a portion of the fourth surface of the second ply and the first low refractive index layer.

Clause 54: The display system of any of clauses 51-53, wherein the first coating further comprises a protective layer over at least a portion of the first high refractive index layer.

Clause 55: The display system of clause 54, wherein the protective layer comprises titania, silica-alumina, zirconia, alloys thereof, mixtures thereof or combinations thereof.

Clause 56: The display system of clause 53, wherein the first coating further comprises a third low refractive index layer positioned over at least a portion of the first high refractive index layer.

Clause 57: The display system of clause 53, wherein the first coating further comprises either a third medium refractive index layer positioned over at least a portion of the third low refractive index layer or a second high refractive index layer positioned over at least a portion of the third low refractive index layer.

Clause 58: The display system of clause 57, wherein the first coating further comprises a protective layer over at least a portion of the third medium refractive index or a protective layer over at least a portion of the second high refractive index.

Clause 59: The display system of clause 58, wherein the either protective layer individually comprises titania, silica-alumina, zirconia, alloys thereof, mixtures thereof or combinations thereof.

Clause 60: The display system of clause 56, wherein the first low refractive index layer, the second low refractive layer and/or the third low refractive layer individually comprises silica, alumina, or silica-alumina.

Clause 61: The display system of clause 57, wherein the first medium refractive index layer, the second medium refractive layer, and/or the third medium refractive index layer individually comprises zinc oxide, zinc-tin oxide, or silicon nitride.

Clause 62: The display system of clause 57, wherein the first high refractive index layer and/or the second high refractive index layer individually comprises metallic silicon, elemental silicon, titania, zirconia, niobium oxide, tantalum oxide, alloys thereof, mixtures thereof, or combinations thereof.

Clause 63: The display system of clause 56, wherein the first low refractive index layer, the second low refractive layer and/or the third low refractive layer comprise a refractive index of 1.4 to 1.6.

Clause 64: The display system of clause 57, wherein the first medium refractive index layer, the second medium refractive layer, and/or the third medium refractive index layer individually comprises a refractive index of 1.61 to 1.9.

Clause 65: The display system of clause 57, wherein the first high refractive index and/or the second high refractive index layer individually comprises a refractive index of 1.91 to 2.2.

Clause 66: The display system of clause 58, wherein either protective layer individually comprises titania, silica-alumina, zirconia, alloys thereof, mixtures thereof or combinations thereof.

Clause 67: The display system of any of clauses 51-53, wherein the first coating further comprises a topcoat layer positioned over at least a portion of the first high refractive index layer.

Clause 68: The display system of clause 57, wherein the first coating further comprises a topcoat layer positioned over at least a portion of the third medium refractive index or a topcoat layer positioned over at least a portion of the second high refractive index.

Clause 69: The display system of clause 52, wherein the second coating further comprises an overcoat positioned over at least a portion of the third dielectric layer.

Clause 70: The display system of any of clauses 51-69, wherein the laminate is free from a polyvinyl butyral (PVB) wedge layer.

Clause 71: The display system of any of clauses 51-70, wherein the first low refractive index layer has a thickness in the range of 200 Å to 450 Å, the first medium refractive index layer has a thickness in the range of 625 Å to 1025 Å, the second low refractive index layer has a thickness in the range of 1350 Å to 1850 Å, and the first high refractive index layer has a thickness in the range of 400 Å to 700 Å.

Clause 72: The display system of any of clauses 51-70, wherein the first low refractive index layer has a thickness in the range of 250 Å to 400 Å, the first medium refractive index layer has a thickness in the range of 700 Å to 950 Å, the second low refractive index layer has a thickness in the range of 1450 Å to 1750 Å, and the first high refractive index layer has a thickness in the range of 475 Å to 625 Å.

Clause 73: The display system of any of clauses 51-70, wherein the first low refractive index layer has a thickness in the range of 275 Å to 375 Å, the first medium refractive index layer has a thickness in the range of 750 Å to 900 Å, the second low refractive index layer has a thickness in the range of 1525 Å to 1675 Å, and the first high refractive index layer has a thickness in the range of 525 Å to 575 Å.

Clause 74: The display system of clause 53, wherein the second medium refractive index layer has a thickness in the range of 200 Å to 350 Å.

Clause 75: The display system of clause 53, wherein the second medium refractive index layer has a thickness in the range of 225 Å to 325 Å.

Clause 76: The display system of clause 57, wherein either the third medium refractive index layer or the second high refractive index layer has a thickness in the range of 10 Å to 200 Å.

Clause 77: The display system of clause 57, wherein either the third medium refractive index layer or the second high refractive index layer individually has a thickness in the range of 25 Å to 185 Å.

Clause 78: The display system of clause 52, wherein the first dielectric layer has a thickness in the range of 230 Å to 310 Å, the first metal layer has a thickness in the range of 90 Å to 130 Å, the first primer layer has a thickness in the range of 20 Å to 45 Å, the second dielectric layer has a thickness in the range of 700 Å to 940 Å, the second metal layer has a thickness in the range of 60 Å to 100 Å, the second primer layer has a thickness in the range of 20 Å to 45 Å, and the third dielectric layer has a thickness in the range of 220 Å to 280 Å.

Clause 79: The display system of clause 52, wherein the first dielectric layer has a thickness in the range of 255 Å to 285 Å, the first metal layer has a thickness in the range of 100 Å to 120 Å, the first primer layer has a thickness in the range of 25 Å to 40 Å, the second dielectric layer has a thickness in the range of 780 Å to 860 Å, the second metal layer has a thickness in the range of 70 Å to 90 Å, the second primer layer has a thickness in the range of 25 Å to 40 Å, and the third dielectric layer has a thickness in the range of 240 Å to 260 Å.

Clause 80: The display system of any of clauses 51-79, wherein the laminate has a p-polarized reflection, as determined at an angle of 60 degrees relative to the normal of the laminate, of at least 12.5 percent of the p-polarized radiation.

Clause 81: The display system of any of clauses 51-79, wherein the laminate has a p-polarized reflection, as determined at an angle of 60 degrees relative to the normal of the laminate, of at least 15 percent of the p-polarized radiation.

Clause 82: The display system of any of clauses 51-81, wherein the laminate has an unpolarized light reflection, as determined at an angle of 60 degrees relative to the normal of the laminate, of less than 30 percent of the unpolarized light.

Clause 83: The display system of any of clauses 51-81, wherein the laminate has an unpolarized light reflection, as determined at an angle of 60 degrees relative to the normal of the laminate, of less than 25 percent of the unpolarized light.

Clause 84: The display system of any of clauses 51-81, wherein the laminate has an unpolarized light reflection, as determined at an angle of 60 degrees relative to the normal of the laminate, of less than 22.5 percent of the unpolarized light.

Clause 85: The display system of any of clauses 51-84, wherein the unpolarized light reflected off the laminate has an a* in the range of −12 to 10, as determined at an angle of 60 degrees relative to the normal of the laminate.

Clause 86: The display system of any of clauses 51-84, wherein the unpolarized light reflected off the laminate has an a* in the range of −11 to 9, as determined at an angle of 60 degrees relative to the normal of the laminate.

Clause 87: The display system of any of clauses 51-84, wherein the unpolarized light reflected off the laminate has an a* in the range of −10 to 8, as determined at an angle of 60 degrees relative to the normal of the laminate.

Clause 88: The display system of any of clauses 51-87, wherein the unpolarized light reflected off the laminate has a b* in the range of −12 to 0, as determined at an angle of 60 degrees relative to the normal of the laminate.

Clause 89: The display system of any of clauses 51-87, wherein the unpolarized light reflected off the laminate has a b* in the range of −11 to −2, as determined at an angle of 60 degrees relative to the normal of the laminate.

Clause 90: The display system of any of clauses 51-87, wherein the unpolarized light reflected off the laminate has a b* in the range of −10 to −3, as determined at an angle of 60 degrees relative to the normal of the laminate.

Clause 91: The display system of any of clauses 51-90, wherein the p-polarized light reflected off the laminate has an a* in the range of −10 to 0, as determined at an angle of 60 degrees relative to the normal of the laminate.

Clause 92: The display system of any of clauses 51-90, wherein the p-polarized light reflected off the laminate has an a* in the range of −7 to −1, as determined at an angle of 60 degrees relative to the normal of the laminate.

Clause 93: The display system of any of clauses 51-90, wherein the p-polarized light reflected off the laminate has an a* in the range of −6 to −2, as determined at an angle of 60 degrees relative to the normal of the laminate.

Clause 94: The display system of any of clauses 51-93, wherein the p-polarized light reflected off the laminate has a b* in the range of 4 to 14, as determined at an angle of 60 degrees relative to the normal of the laminate.

Clause 95: The display system of any of clauses 51-93, wherein the p-polarized light reflected off the laminate has a b* in the range of 5 to 13, as determined at an angle of 60 degrees relative to the normal of the laminate.

Clause 96: The display system of any of clauses 51-93, wherein the p-polarized light reflected off the laminate has a b* in the range of 6 to 12, as determined at an angle of 60 degrees relative to the normal of the laminate.

Clause 97: The display system of any of clauses 51-96, wherein the laminate has an LTA of at least 70 percent.

Clause 98: The display system of any of clauses 51-96, wherein the laminate has an LTA of at least 74 percent.

Clause 99: The display system of any of clauses 51-96, wherein the laminate has an LTA of at least 75 percent.

Clause 100: The display system of any of clauses 51-99, wherein, when the laminate is applied to one side of a glass substrate, the RgY, the percent reflection of visible light from the unlaminated glass side, is within ±1.5 percent of the RfY, the percent reflection of visible light from the laminated glass side.

Clause 101: A laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the surfaces of the first ply and/or the second ply, wherein the enhanced p-polarized reflective coating comprises a base layer positioned over the portion of the at least one of the surfaces; a first metal functional layer positioned over at least a portion of the base layer; a first phase adjustment layer positioned over at least a portion of the first metal functional layer; a second metal functional layer positioned over at least a portion of the first phase adjustment layer; a topcoat layer positioned over at least a portion of the second metal functional layer; and an overcoat positioned over at least a portion of the topcoat layer; wherein the laminate has a p-polarized reflection, as determined at an angle of 60 degrees relative to the normal of the laminate, of at least 10 percent of the p-polarized radiation at one or more wavelengths of at least 450 nm, 530 nm, and/or 620 nm.

Clause 102: The laminate of clause 101, wherein a coating incidence angle θ_{c} of the enhanced p-polarized reflective coating is selected such that an incidence angle θ_{b} at the first is the Brewster's angle for the glass to air interface.

Clause 103: The laminate of clause 101, wherein the coating incidence angle θ_{c} is selected such that the incidence angle θ_{b} is 33 degrees.

Clause 104: The laminate of any of clauses 101-103, wherein the enhanced p-polarized reflective coating further comprises a second phase adjustment layer positioned over at least a portion of the second metal functional layer; a third metal functional layer positioned over at least a portion of the second phase adjustment layer; the topcoat layer positioned over at least a portion of the third metal functional layer; and the overcoat positioned over at least a portion of the topcoat layer.

Clause 105: The laminate of clause 104, wherein the first phase adjustment layer and/or the second phase adjustment layer comprises a first film comprising a metal oxide film; a second film positioned over the first film of the first phase adjustment layer and/or the second phase adjustment layer, the second film of the first phase adjustment layer and/or the second phase adjustment layer comprising a metal-alloy oxide film; and a third film positioned over the second film of the first phase adjustment layer and/or the second phase adjustment layer, the third film of the first phase adjustment layer and/or the second phase adjustment layer comprising a metal oxide film.

Clause 106: The laminate of any of clauses 101-105, wherein the base layer has a thickness of 350-410 Å, the first metal functional layer has a thickness in the range of 60-75 Å, the first phase adjustment layer has a thickness in the range of 840-925 Å, and the second metal functional layer has a thickness in the range of 120-150 Å.

Clause 107: The laminate of any of clauses 101-105, wherein the base layer has a thickness of 375-390 Å, the first metal functional layer has a thickness in the range of 62-72 Å, the first phase adjustment layer has a thickness in the range of 860-910 Å, the second metal functional layer has a thickness in the range of 130-145 Å, the topcoat layer has a thickness in the range of 300-400 Å, and the overcoat layer has a thickness in the range of 550-650 Å.

Clause 108: The laminate of clause 104, wherein the base layer has a thickness of 350-410 Å, the first metal functional layer has a thickness in the range of 60-75 Å, the first phase adjustment layer has a thickness in the range of 840-925 Å, the second metal functional layer has a thickness in the range of 120-150 Å, the second phase adjustment layer has a thickness in the range of 600-825 Å, and the third metal functional layer has a thickness in the range of 65-135 Å.

Clause 109: The laminate of clause 104, wherein the base layer has a thickness of 375-390 Å, the first metal functional layer has a thickness in the range of 62-72 Å, the first phase adjustment layer has a thickness in the range of 860-910 Å, the second metal functional layer has a thickness in the range of 130-145 Å, the second phase adjustment layer has a thickness in the range of 615-820 Å, the third metal functional layer has a thickness in the range of 65-135 Å, the topcoat layer has a thickness in the range of 300-400 Å, and the overcoat layer has a thickness in the range of 550-650 Å.

Clause 110: The laminate of clause 101, wherein the first metal functional layer or the second metal functional layer comprises silver, and the system does not include any other metal functional layers.

Clause 111: The laminate of clause 104, wherein the first metal functional layer, the second metal functional layer, or the third metal functional layer comprises silver, and the system does not include any other metal functional layers.

Clause 112: The laminate of any of clauses 101-111, wherein the enhanced p-polarized reflective coating further comprises a first primer layer positioned between the first metal functional layer and the first phase adjustment layer.

Clause 113: The laminate of any of clauses 101-112, wherein the enhanced p-polarized reflective coating further comprises a second primer layer positioned between the second metal functional layer, and the topcoat layer.

Clause 114: The laminate of clause 104, wherein the enhanced p-polarized reflective coating further comprises a third primer layer positioned over at least a portion of the third metal functional layer.

Clause 115: The laminate of any of clauses 101-114, wherein the laminate has a p-polarized reflection, as determined at an angle of 60 degrees relative to the normal of the laminate, of at least 12.5 percent of the p-polarized radiation.

Clause 116: The laminate of any of clauses 101-115, wherein the laminate has a p-polarized reflection, as determined at an angle of 60 degrees relative to the normal of the laminate, of at least 15 percent of the p-polarized radiation.

Clause 117: A display system for projecting an image comprising a laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the surfaces of the first ply and/or the second ply, wherein the enhanced p-polarized reflective coating comprises a base layer positioned over the portion of the at least one of the surfaces; first metal functional layer positioned over at least a portion of the base layer; a first phase adjustment layer positioned over at least a portion of the first metal functional layer; a second metal functional layer positioned over at least a portion of the first phase adjustment layer; a topcoat layer positioned over at least a portion of the second metal functional layer; and an overcoat positioned over at least a portion of the topcoat layer; wherein the laminate has a p-polarized reflection, as determined at an angle of 60 degrees relative to the normal of the laminate, of at least 10 percent of the p-polarized radiation at one or more wavelengths of at least 450 nm, 530 nm, and/or 620 nm. In still another embodiment, the display system of this clause, or of any one or more of clauses 118-134, can further include at least one suitable radiation source as described herein.

Clause 118: The display system of clause 117, wherein a coating incidence angle θ_{c} of the enhanced p-polarized reflective coating is selected such that an incidence angle θ_{b} at the first is the Brewster's angle for the glass to air interface.

Clause 119: The display system of clause 117, wherein the coating incidence angle θ_{c} is selected such that the incidence angle θ_{b} is 33 degrees.

Clause 120: The display system of any of clauses 117-119, wherein the enhanced p-polarized reflective coating further comprises a second phase adjustment layer positioned over at least a portion of the second metal functional layer; a third metal functional layer positioned over at least a portion of the second phase adjustment layer; the topcoat layer positioned over at least a portion of the third metal functional layer; and the overcoat positioned over at least a portion of the topcoat layer.

Clause 121: The display system of clause 120, wherein the first phase adjustment layer and/or the second phase adjustment layer comprises a first film comprising a metal oxide film; a second film positioned over the first film of the first phase adjustment layer and/or the second phase adjustment layer, the second film of the first phase adjustment layer and/or the second phase adjustment layer comprising a metal-alloy oxide film; and a third film positioned over the second film of the first phase adjustment layer and/or the second phase adjustment layer, the third film of the first phase adjustment layer and/or the second phase adjustment layer comprising a metal oxide film.

Clause 122: The display system of any of clauses 117-121, wherein the base layer has a thickness of 350-410 Å, the first metal functional layer has a thickness in the range of 60-75 Å, the first phase adjustment layer has a thickness in the range of 840-925 Å, and the second metal functional layer has a thickness in the range of 120-150 Å.

Clause 123: The display system of any of clauses 117-121, wherein the base layer has a thickness of 375-390 Å, the first metal functional layer has a thickness in the range of 62-72 Å, the first phase adjustment layer has a thickness in the range of 860-910 Å, the second metal functional layer has a thickness in the range of 130-145 Å, the topcoat layer has a thickness in the range of 300-400 Å, and the overcoat layer has a thickness in the range of 550-650 Å.

Clause 124: The display system of clause 120, wherein the base layer has a thickness of 350-410 Å, the first metal functional layer has a thickness in the range of 60-75 Å, the first phase adjustment layer has a thickness in the range of 840-925 Å, the second metal functional layer has a thickness in the range of 120-150 Å, the second phase adjustment layer has a thickness in the range of 600-825 Å, and the third metal functional layer has a thickness in the range of 65-135 Å.

Clause 125: The display system of clause 120, wherein the base layer has a thickness of 375-390 Å, the first metal functional layer has a thickness in the range of 62-72 Å, the first phase adjustment layer has a thickness in the range of 860-910 Å, the second metal functional layer has a thickness in the range of 130-145 Å, the second phase adjustment layer has a thickness in the range of 615-820 Å, the third metal functional layer has a thickness in the range of 65-135 Å, the topcoat layer has a thickness in the range of 300-400 Å, and the overcoat layer has a thickness in the range of 550-650 Å.

Clause 126: The display system of clause 117, wherein the first metal functional layer or the second metal functional layer comprises silver, and the system does not include any other metal functional layers.

Clause 127: The display system of clause 120, wherein the first metal functional layer, the second metal functional layer, or the third metal functional layer comprises silver, and the system does not include any other metal functional layers.

Clause 128: The display system of any of clauses 117-127, wherein the enhanced p-polarized reflective coating further comprises a first primer layer positioned between the first metal functional layer and the first phase adjustment layer.

Clause 129: The display system of any of clauses 117-128, wherein the enhanced p-polarized reflective coating further comprises a second primer layer positioned between the second metal functional layer and the topcoat layer.

Clause 130: The display system of clause 120, wherein the enhanced p-polarized reflective coating further comprises a third primer layer positioned over at least a portion of the third metal functional layer.

Clause 131: The display system of any of clauses 117-130, wherein the laminate has a p-polarized reflection, as determined at an angle of 60 degrees relative to the normal of the laminate, of at least 12.5 percent of the p-polarized radiation.

Clause 132: The display system of any of clauses 117-130, wherein the laminate has a p-polarized reflection, as determined at an angle of 60 degrees relative to the normal of the laminate, of at least 15 percent of the p-polarized radiation.

Clause 133: The display system of any of clauses 117-132, further comprising a polarized filter positioned between the light source and the laminate and configured to allow at least a portion of the p-polarized radiation to pass therethrough.

Clause 134: The display system of any of clauses 117-132, wherein the enhanced p-polarized reflective coating is positioned over at least a portion of the fourth surface and a radiation source directed at the laminate is positioned at an angle relative to the laminate such that the radiation contacts the first surface at an angle substantially equal to a Brewster's angle for a first surface to air interface, or wherein the enhanced p-polarized reflective coating is positioned over at least a portion of the first surface and a radiation source directed at the laminate is positioned at an angle relative to the laminate such that the radiation contacts the fourth surface at an angle substantially equal to a Brewster's angle for an air to fourth surface interface.

Clause 135: A method of projecting an image in a heads-up display comprising providing a laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the surfaces of the first ply and/or the second ply, wherein the laminate has a p-polarized reflection, as determined at an angle of 60 degrees relative to the normal of the laminate, of at least 10 percent of the p-polarized radiation at one or more wavelengths of at least 450 nm, 530 nm, and/or 620 nm; and directing a radiation source emitting the radiation comprising p-polarized radiation at the laminate, such that an image is projected to an area of an inner side of the laminate.

Clause 136: The method of clause 135, wherein a coating incidence angle θ_{c} of the enhanced p-polarized reflective coating is selected such that an incidence angle θ_{b} at the first is the Brewster's angle for the glass to air interface.

Clause 137: A laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and a first coating positioned over at least a portion of the fourth surface, wherein the first coating comprises a first high refractive index layer positioned over at least a portion of the fourth surface of the second ply; a first low refractive index layer positioned over at least a portion of the first high refractive index layer; a second high refractive index layer positioned over at least a portion of the first low refractive index layer; and a second low refractive index layer positioned over at least a portion of the second high refractive index layer, wherein the laminate has a p-polarized reflection, as determined at an angle of 70 degrees (rather than 60 degrees as shown with regard to FIG. 7) relative to the normal of the laminate, of at least 37, at least 38, or even at least 40 percent of the p-polarized radiation at one or more wavelengths of at least 450 nm, 530 nm, and/or 620 nm.

Clause 138: The laminate of clause 137, wherein the laminate further comprises a second coating as described herein that is positioned over at least a portion of the second surface or the third surface and that functions as, in one embodiment, a solar control coating.

Clause 139: The laminate of any of clauses 137 or 138, wherein the laminate has a maximum reflectance of unpolarized light as determined at an angle of 70 degrees relative to the normal of the laminate of less than 28 percent, less than 27 percent, less than 26 percent, or even less than 25 percent at at least a wavelength of 550 nm.

Clause 140: The laminate of any of clauses 137-139, wherein when the laminate is applied to one side of a glass substrate the RfY for unpolarized light, as determined by the D65 testing procedure described below, is below 26 percent while the p-polarized radiation reflectance, as also determined by the D65 testing procedure described below at at least a wavelength of 550 nm, is at least 40 percent at one or more wavelengths of at least 450 nm, 530 nm, and/or 620 nm.

Clause 141: The laminate of any of clauses 137-140, wherein when the laminate is applied to one side of a glass substrate the p-polarized radiation reflectance, as determined by the D65 testing procedure described below, is at least 40 percent in the wavelength range of at 450 nm to 620 nm.

Clause 142: The laminate of any of clauses 137-141, wherein the first high refractive index layer is formed from any suitable material that comprises a refractive index of 1.91 to 2.2.

Clause 143: The laminate of any of clauses 137-142, wherein the first high refractive index layer is formed from titania.

Clause 144: The laminate of any of clauses 137-143, wherein the first high refractive index layer has a thickness in the range of 75 Å and 650 Å, or in the range of 100 Å to 600 Å, or in the range of 125 Å to 575 Å, or in the range of 150 Å to 550 Å, or in the range of 175 Å to 500 Å, or even in the range of 180 Å to 225 Å.

Clause 145: The laminate of any of clauses 137-144, wherein the first low refractive index layer is formed from any suitable material that comprises a refractive index of 1.4 to 1.6.

Clause 146: The laminate of any of clauses 137-145, wherein the first low refractive index layer is formed from silica, alumina, or silica-alumina

Clause 147: The laminate of any of clauses 137-145, wherein the first low refractive index layer is formed from formed from a silica-alumina composition having 85 weight percent silica to 15 weight percent alumina

Clause 148: The laminate of any of clauses 137-147, wherein the first low refractive index layer has a thickness in the range of 175 Å and 650 Å, or in the range of 200 Å to 600 Å, or in the range of 225 Å to 575 Å, or in the range of 250 Å to 550 Å, or in the range of 275 Å to 500 Å, or even in the range of 300 Å to 400 Å.

Clause 149: The laminate of any of clauses 137-148, wherein the second high refractive index layer is formed from any suitable material that comprises a refractive index of 1.91 to 4, or 2.4 to 4, or 2.5 to 3.9, or even 2.7 to 3.7.

Clause 150: The laminate of any of clauses 137-149, wherein the second high refractive index layer is formed from metallic silicon (or elemental silicon) via the deposition of a 90 weight percent silicon to 10 weight percent aluminum layer under a non-oxidizing atmosphere such as an argon atmosphere.

Clause 151: The laminate of any of clauses 137-149, wherein the second high refractive index layer is formed from silicon (or even metallic silicon or elemental silicon) so long as this layer is formed under a non-oxidizing atmosphere such as an argon atmosphere, boron-doped silicon, or even gallium arsenide.

Clause 152: The laminate of any of clauses 137-151, wherein the second high refractive index layer has a thickness in the range of 250 Å and 400 Å, or in the range of 275 Å to 375 Å, or in the range of 300 Å to 350 Å, or even in the range of 310 Å to 340 Å.

Clause 153: The laminate of any of clauses 137-152, wherein the second low refractive index layer is formed from any suitable material that comprises a refractive index of 1.4 to 1.6.

Clause 154: The laminate of any of clauses 137-153, wherein the second low refractive index layer is formed from silica, alumina, or silica-alumina

Clause 155: The laminate of any of clauses 137-154, wherein the second low refractive index layer is formed from formed from a silica-alumina composition having 85 weight percent silica to 15 weight percent alumina

Clause 156: The laminate of any of clauses 137-155, wherein the second low refractive index layer has a thickness in the range of 800 Å and 1350 Å, or in the range of 850 Å to 1300 Å, or in the range of 900 Å to 1250 Å, or even in the range of 950 Å to 1200 Å.

Clause 157: The laminate of any of clauses 137-156, wherein the laminate further comprises one or more of a protective layer, a topcoat layer, and/or an overcoat layer as described herein, where such one or more layers are all located on top of and above the second low refractive index layer.

Clause 158: The laminate of any of clauses 1-157, wherein the interlayer is eliminated and not used in any of the laminates.

### BRIEF DESCRIPTION OF THE DRAWINGS

FIG. 1 is a perspective view (not to scale) of a display system including a laminate and a radiation source;

FIGS. 2A-2F are side views (not to scale) of various examples of a laminate having an enhanced p-polarized reflective coating;

FIGS. 3A and 3B are side views (not to scale) of enhanced p-polarized reflective coatings located over a substrate;

FIGS. 4A and 4B are side views (not to scale) of enhanced p-polarized reflective coatings located over a substrate;

FIG. 5A is a side view (not to scale) of a laminate including two plies and having a wedge-shaped interlayer;

FIG. 5B is a side view (not to scale) of a laminate including two plies having an interlayer of continuous thickness;

FIG. 6 is a perspective view (not to scale) of a laminate having an enhanced p-polarized reflective coating on a fourth surface and a radiation source positioned such that radiation from the radiation source contacts a first surface of the laminate at a Brewster's angle of a first surface to air interface; and

FIG. 7 is a perspective view (not to scale) of a test apparatus for which radiation from a radiation source contacts a laminate at an angle of 60 degrees relative to normal of the laminate.

### DETAILED DESCRIPTION OF THE INVENTION

For purposes of the description hereinafter, the terms “end”, “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

Moreover, other than in any operating examples, or where otherwise indicated, all numbers used in the specification and claims are to be understood as being modified in all instances by the term “about”. Accordingly, unless indicated to the contrary, the numerical parameters set forth in the following specification and attached claims are approximations that can vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

With respect to coating layers described herein, the term “over” means farther from the substrate on which the coating layer is positioned. For example, a second layer positioned “over” a first layer means that the second layer is positioned farther from the substrate than is the first layer. The second layer can be in direct contact with the first layer. Alternatively, one or more other layers can be positioned between the first layer and the second layer.

The term “film” means a region having a distinct composition. A “layer” can include one or more “films”. A “coating” can include one or more “layers”.

The terms “polymer” or “polymeric” include oligomers, homopolymers, copolymers, and terpolymers, e.g., polymers formed from two or more types of monomers or polymers.

The term “ultraviolet radiation” means electromagnetic radiation having a wavelength in the range of 100 nm to less than 300 nm. The term “visible radiation” means electromagnetic radiation having a wavelength in the range of 380 nm to 780 nm. The term “infrared radiation” means electromagnetic radiation having a wavelength in the range of greater than 780 nm to 100,000 nm. The term “solar infrared radiation” means electromagnetic radiation having a wavelength in the range of 1,000 nm to 3,000 nm. The term “thermal infrared radiation” means electromagnetic radiation having a wavelength in the range of greater than 3,000 nm to 20,000 nm.

The terms “metal” and “metal oxide” include silicon and silica, respectively, as well as traditionally recognized metals and metal oxides, even though silicon conventionally may not be considered a metal. By “at least” is meant “greater than or equal to”. By “not greater than” is meant “less than or equal to”. The term “includes” is synonymous with “comprises”.

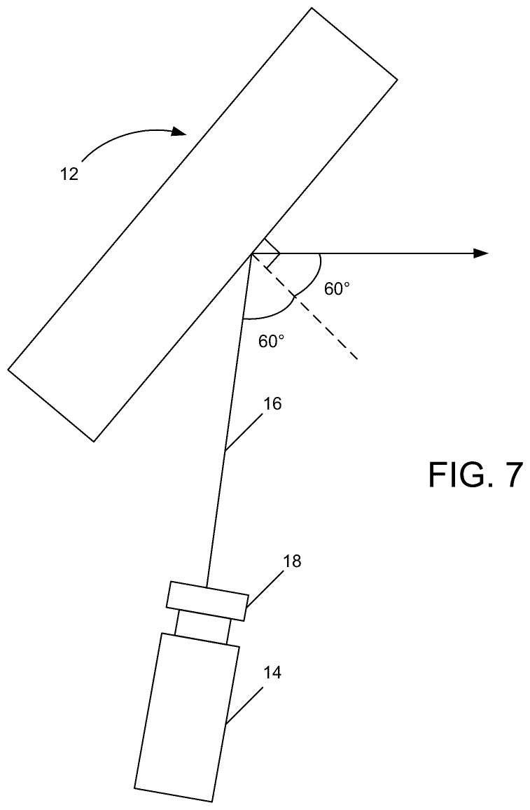

A “reference laminated unit” is defined as a laminate having two pieces of 2 mm clear float glass separated by a 0.76 mm layer of PVB with the enhanced p-polarized reflective coating on the No. 3 surface. By “reference laminated value” is meant the reported value, e.g., LTA, reflectance, etc., measured for the laminated unit using the test apparatus shown in FIG. 7 of U.S. Pat. Nos. 10,788,667 and 11,630,301, the complete disclosures of which are incorporated herein in their entireties.

The discussion of the invention may describe certain features as being “particularly” or “preferably” within certain limitations (e.g., “preferably”, “more preferably”, or “even more preferably”, within certain limitations). It is to be understood that the invention is not limited to these particular or preferred limitations but encompasses the entire scope of the disclosure.

Given the above, in one embodiment, the present invention relates to a laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and a first coating positioned over at least a portion of the fourth surface, wherein the first coating comprises a first low refractive index layer positioned over at least a portion of the fourth surface of the second ply; a first medium refractive index layer positioned over at least a portion of the first low refractive index layer; a second low refractive index layer positioned over at least a portion of the first medium refractive index layer; and a first high refractive index layer positioned over at least a portion of the second low refractive index layer, wherein the laminate has a p-polarized reflection, as determined at an angle of 60 degrees relative to the normal of the laminate, of at least 10 percent of the p-polarized radiation at one or more wavelengths of at least 450 nm, 530 nm, and/or 620 nm. In still another embodiment, the laminate further comprises a second coating that is positioned over at least a portion of the second surface or the third surface.

In another embodiment, the laminate of the present invention further comprises a second coating positioned over at least a portion of the second surface or the third surface, where such a second coating comprises a first dielectric layer positioned over the portion of the at least one of the second surface and/or the third surface; a first metal layer positioned over at least a portion of the first dielectric layer; a first primer layer positioned over at least a portion of the first metal functional layer; a second dielectric layer positioned over at least a portion of the first primer layer; a second metal layer positioned over at least a portion of the second dielectric layer; a second primer layer positioned over at least a portion of the second metal functional layer; and a third dielectric layer positioned over at least a portion of the second primer layer. In still another embodiment, the laminate of the present invention has a first coating that further comprises a second medium refractive index layer positioned between at least a portion of the fourth surface of the second ply and the first low refractive index layer.

In still yet another embodiment, the first coating further comprises a protective layer over at least a portion of the first high refractive index layer. In still yet another embodiment, the protective layer of the present invention comprises, among other suitable materials disclosed herein, titania, silica-alumina, zirconia, alloys thereof, mixtures thereof or combinations thereof. In still yet another embodiment, the first coating further comprises a third low refractive index layer positioned over at least a portion of the first high refractive index layer. In still yet another embodiment, the first coating further comprises either a third medium refractive index layer positioned over at least a portion of the third low refractive index layer or a second high refractive index layer positioned over at least a portion of the third low refractive index layer.

In still yet another embodiment, the first coating further comprises a protective layer over at least a portion of the third medium refractive index or a protective layer over at least a portion of the second high refractive index. In still yet another embodiment, either of these protective layers individually comprises, among other suitable materials disclosed herein, titania, silica-alumina, zirconia, alloys thereof, mixtures thereof or combinations thereof.

In still yet another embodiment, the first low refractive index layer, the second low refractive layer and/or the third low refractive layer individually comprises, among other suitable materials disclosed herein, silica, alumina, or silica-alumina. In still yet another embodiment, the first medium refractive index layer, the second medium refractive layer, and/or the third medium refractive index layer individually comprises zinc oxide, zinc-tin oxide, or silicon nitride. In still yet another embodiment, the first high refractive index layer and/or the second high refractive index layer individually comprises, among other suitable materials disclosed herein, metallic silicon, elemental silicon, titania, zirconia, niobium oxide, tantalum oxide, alloys thereof, mixtures thereof, or combinations thereof. In still yet another embodiment, the first low refractive index layer, the second low refractive layer and/or the third low refractive layer comprise a refractive index of 1.4 to 1.6.

In still yet another embodiment, the first medium refractive index layer, the second medium refractive layer, and/or the third medium refractive index layer individually comprises a refractive index of 1.61 to 1.9. In still yet another embodiment, the first high refractive index and/or the second high refractive index layer individually comprises a refractive index of 1.91 to 2.2. In still yet another embodiment, the first coating further comprises a topcoat layer positioned over at least a portion of the first high refractive index layer.

In still yet another embodiment, the first coating further comprises a topcoat layer positioned over at least a portion of the third medium refractive index or a topcoat layer positioned over at least a portion of the second high refractive index. In still yet another embodiment, the second coating further comprises an overcoat positioned over at least a portion of the third dielectric layer. In still yet another embodiment, the laminate of the present invention can be free from a polyvinyl butyral (PVB) wedge layer.

In one embodiment, the first low refractive index layer has a thickness in the range of 200 Å to 450 Å, the first medium refractive index layer has a thickness in the range of 625 Å to 1025 Å, the second low refractive index layer has a thickness in the range of 1350 Å to 1850 Å, and the first high refractive index layer has a thickness in the range of 400 Å to 700 Å. In another embodiment, the first low refractive index layer has a thickness in the range of 250 Å to 400 Å, the first medium refractive index layer has a thickness in the range of 700 Å to 950 Å, the second low refractive index layer has a thickness in the range of 1450 Å to 1750 Å, and the first high refractive index layer has a thickness in the range of 475 Å to 625 Å.

In still another embodiment, the first low refractive index layer has a thickness in the range of 275 Å to 375 Å, the first medium refractive index layer has a thickness in the range of 750 Å to 900 Å, the second low refractive index layer has a thickness in the range of 1525 Å to 1675 Å, and the first high refractive index layer has a thickness in the range of 525 Å to 575 Å.

In still another embodiment, the second medium refractive index layer has a thickness in the range of 200 Å to 350 Å. In still another embodiment, the second medium refractive index layer has a thickness in the range of 225 Å to 325 Å. In still another embodiment, the third medium refractive index layer or the second high refractive index layer has a thickness in the range of 10 Å to 200 Å.

In still another embodiment, either the third medium refractive index layer or the second high refractive index layer individually has a thickness in the range of 25 Å to 185 Å. In still yet another embodiment, the first dielectric layer has a thickness in the range of 230 Å to 310 Å, the first metal layer has a thickness in the range of 90 Å to 130 Å, the first primer layer has a thickness in the range of 20 Å to 45 Å, the second dielectric layer has a thickness in the range of 700 Å to 940 Å, the second metal layer has a thickness in the range of 60 Å to 100 Å, the second primer layer has a thickness in the range of 20 Å to 45 Å, and the third dielectric layer has a thickness in the range of 220 Å to 280 Å.

In still another embodiment, the first dielectric layer has a thickness in the range of 255 Å to 285 Å, the first metal layer has a thickness in the range of 100 Å to 120 Å, the first primer layer has a thickness in the range of 25 Å to 40 Å, the second dielectric layer has a thickness in the range of 780 Å to 860 Å, the second metal layer has a thickness in the range of 70 Å to 90 Å, the second primer layer has a thickness in the range of 25 Å to 40 Å, and the third dielectric layer has a thickness in the range of 240 Å to 260 Å.

In still another embodiment, the laminate of the present invention has a p-polarized reflection, as determined at an angle of 60 degrees relative to the normal of the laminate, of at least 12.5 percent of the p-polarized radiation, or even of at least 15 percent of the p-polarized radiation. In still another embodiment, the laminate of the present invention has an unpolarized light reflection, as determined at an angle of 60 degrees relative to the normal of the laminate, of less than 30 percent of the unpolarized light, or less than 25 percent of the unpolarized light, or even less than 22.5 percent of the unpolarized light.

In still another embodiment, the unpolarized light reflected off the laminate of the present invention has an a* in the range of −12 to 10, as determined at an angle of 60 degrees relative to the normal of the laminate, an a* in the range of −11 to 9, as determined at an angle of 60 degrees relative to the normal of the laminate, or even an a* in the range of −10 to 8, as determined at an angle of 60 degrees relative to the normal of the laminate. In still another embodiment, the unpolarized light reflected off the laminate of the present invention has a b* in the range of −12 to 0, has a b* in the range of −11 to −2, or even has a b* in the range of −10 to −3, as determined at an angle of 60 degrees relative to the normal of the laminate.

In still another embodiment, the p-polarized light reflected off the laminate has an a* in the range of −10 to 0, has an a* in the range of −7 to −1, or even has an a* in the range of −6 to −2, as determined at an angle of 60 degrees relative to the normal of the laminate. In still another embodiment, the p-polarized light reflected off the laminate of the present invention has a b* in the range of 4 to 14, has a b* in the range of 5 to 13, or even has a b* in the range of 6 to 12, as determined at an angle of 60 degrees relative to the normal of the laminate.

In still another embodiment, the laminate of the present invention has an LTA of at least 70 percent, of at least 74 percent, or even of at least 75 percent. In still another embodiment, when the laminate of the present invention is applied to one side of a glass substrate, the RfY, the percent reflection of visible light from the unlaminated glass side, is within ±1.5 percent of the RfY, the percent reflection of visible light from the laminate side.

In another embodiment, the present invention relates to a display system for projecting an image comprising a laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and a first coating positioned over at least a portion of the fourth surface, wherein the first coating comprises a first low refractive index layer positioned over at least a portion of the fourth surface of the second ply; a first medium refractive index layer positioned over at least a portion of the first low refractive index layer; a second low refractive index layer positioned over at least a portion of the first medium refractive index layer; and a first high refractive index layer positioned over at least a portion of the second low refractive index layer, wherein the laminate has a p-polarized reflection, as determined at an angle of 60 degrees relative to the normal of the laminate, of at least 10 percent of the p-polarized radiation at one or more wavelengths of at least 450 nm, 530 nm, and/or 620 nm. In still another embodiment, the laminate further comprises a second coating that is positioned over at least a portion of the second surface or the third surface. In still another embodiment, the display system of this embodiment of the present invention can further include at least one suitable radiation source as described herein.

In still another embodiment, the display systems of the present invention can further comprise any of the laminate embodiments disclosed herein. In still another embodiment, the display system of the present invention utilizes any of the laminates disclosed herein such that when any one of the laminates of the present are applied to one side of a glass substrate the RgY, the percent reflection of visible light from the unlaminated glass side, is within ±1.5 percent of the RfY, the percent reflection of visible light from the laminated glass side.

In another embodiment, the present invention relates to a laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the surfaces of the first ply and/or the second ply, wherein the enhanced p-polarized reflective coating comprises a base layer positioned over the portion of the at least one of the surfaces; a first metal functional layer positioned over at least a portion of the base layer; a first phase adjustment layer positioned over at least a portion of the first metal functional layer; a second metal functional layer positioned over at least a portion of the first phase adjustment layer; a topcoat layer positioned over at least a portion of the second metal functional layer; and an overcoat positioned over at least a portion of the topcoat layer; wherein the laminate has a p-polarized reflection, as determined at an angle of 60 degrees relative to the normal of the laminate, of at least 10 percent of the p-polarized radiation at one or more wavelengths of at least 450 nm, 530 nm, and/or 620 nm.

In still another embodiment, the laminate of the present invention has a coating incidence angle θ_{c} of the enhanced p-polarized reflective coating that is selected such that an incidence angle θ_{b} at the first is the Brewster's angle for the glass to air interface. In still another embodiment, the laminate of the present invention has a coating incidence angle θ_{c} that is selected such that the incidence angle θ_{b} is 33 degrees.

In still another embodiment, the enhanced p-polarized reflective coating of the present invention further comprises a second phase adjustment layer positioned over at least a portion of the second metal functional layer; a third metal functional layer positioned over at least a portion of the second phase adjustment layer; the topcoat layer positioned over at least a portion of the third metal functional layer; and the overcoat positioned over at least a portion of the topcoat layer.

In still another embodiment, the first phase adjustment layer and/or the second phase adjustment layer of the present invention comprises a first film comprising a metal oxide film; a second film positioned over the first film of the first phase adjustment layer and/or the second phase adjustment layer, the second film of the first phase adjustment layer and/or the second phase adjustment layer comprising a metal-alloy oxide film; and a third film positioned over the second film of the first phase adjustment layer and/or the second phase adjustment layer, the third film of the first phase adjustment layer and/or the second phase adjustment layer comprising a metal oxide film.

In still another embodiment, the base layer has a thickness of 350-410 Å, the first metal functional layer has a thickness in the range of 60-75 Å, the first phase adjustment layer has a thickness in the range of 840-925 Å, and the second metal functional layer has a thickness in the range of 120-150 Å. In still another embodiment, the base layer has a thickness of 375-390 Å, the first metal functional layer has a thickness in the range of 62-72 Å, the first phase adjustment layer has a thickness in the range of 860-910 Å, the second metal functional layer has a thickness in the range of 130-145 Å, the topcoat layer has a thickness in the range of 300-400 Å, and the overcoat layer has a thickness in the range of 550-650 Å.

In still another embodiment, the base layer has a thickness of 350-410 Å, the first metal functional layer has a thickness in the range of 60-75 Å, the first phase adjustment layer has a thickness in the range of 840-925 Å, the second metal functional layer has a thickness in the range of 120-150 Å, the second phase adjustment layer has a thickness in the range of 600-825 Å, and the third metal functional layer has a thickness in the range of 65-135 Å. In still another embodiment, the base layer has a thickness of 375-390 Å, the first metal functional layer has a thickness in the range of 62-72 Å, the first phase adjustment layer has a thickness in the range of 860-910 Å, the second metal functional layer has a thickness in the range of 130-145 Å, the second phase adjustment layer has a thickness in the range of 615-820 Å, the third metal functional layer has a thickness in the range of 65-135 Å, the topcoat layer has a thickness in the range of 300-400 Å, and the overcoat layer has a thickness in the range of 550-650 Å.

In still another embodiment, the first metal functional layer and the second metal functional layer have a combined thickness in the range of 60-200 Å. In still another embodiment, the first metal functional layer or the second metal functional layer comprises silver, and the system does not include any other metal functional layers. In still another embodiment, the first metal functional layer, the second metal functional layer, and the third metal functional layer have a combined thickness in the range of 240-360 Å. In still another embodiment, the first metal functional layer, the second metal functional layer, or the third metal functional layer comprises silver, and the system does not include any other metal functional layers.

In still another embodiment, the base layer, the first phase adjustment layer and the topcoat have a combined thickness in the range of 1450-1750 Å. In still another embodiment, the enhanced p-polarized reflective coating further comprises a first primer layer positioned between the first metal functional layer and the first phase adjustment layer. In still another embodiment, the enhanced p-polarized reflective coating further comprises a second primer layer positioned between the second metal functional layer and the topcoat layer. In still another embodiment, the first phase adjustment layer and the second phase adjustment layer have a combined thickness in the range of 1450-1750.

In still another embodiment, the enhanced p-polarized reflective coating further comprises a third primer layer positioned over at least a portion of the third metal functional layer. In still another embodiment, the laminate of the present invention has a p-polarized reflection, as determined at an angle of 60 degrees relative to the normal of the laminate, of at least 12.5 percent of the p-polarized radiation. In still another embodiment, the laminate of the present invention has a p-polarized reflection, as determined at an angle of 60 degrees relative to the normal of the laminate, of at least 15 percent of the p-polarized radiation.

In another embodiment, the present invention relates to a display system for projecting an image comprising a laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the surfaces of the first ply and/or the second ply, wherein the enhanced p-polarized reflective coating comprises a base layer positioned over the portion of the at least one of the surfaces; first metal functional layer positioned over at least a portion of the base layer; a first phase adjustment layer positioned over at least a portion of the first metal functional layer; a second metal functional layer positioned over at least a portion of the first phase adjustment layer; a topcoat layer positioned over at least a portion of the second metal functional layer; and an overcoat positioned over at least a portion of the topcoat layer; wherein the laminate has a p-polarized reflection, as determined at an angle of 60 degrees relative to the normal of the laminate, of at least 10 percent of the p-polarized radiation at one or more wavelengths of at least 450 nm, 530 nm, and/or 620 nm. In still another embodiment, the display system of this embodiment of the present invention can further include at least one suitable radiation source as described herein.

In still another embodiment, the display system of the present invention for projecting an image can further comprise any of the laminate embodiments disclosed herein. In still another embodiment, the display system of the present invention further comprises a polarized filter positioned between the light source and the laminate and configured to allow at least a portion of the p-polarized radiation to pass therethrough. In still another embodiment, the enhanced p-polarized reflective coating is positioned over at least a portion of the fourth surface and a radiation source directed at the laminate is positioned at an angle relative to the laminate such that the radiation contacts the first surface at an angle substantially equal to a Brewster's angle for a first surface to air interface, or wherein the enhanced p-polarized reflective coating is positioned over at least a portion of the first surface and a radiation source directed at the laminate is positioned at an angle relative to the laminate such that the radiation contacts the fourth surface at an angle substantially equal to a Brewster's angle for an air to fourth surface interface.

In another embodiment, the present invention relates to a method of projecting an image in a heads-up display comprising providing a laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the surfaces of the first ply and/or the second ply, wherein the laminate has a p-polarized reflection, as determined at an angle of 60 degrees relative to the normal of the laminate, of at least 10 percent of the p-polarized radiation at one or more wavelengths of at least 450 nm, 530 nm, and/or 620 nm; and directing a radiation source emitting the radiation comprising p-polarized radiation at the laminate, such that an image is projected to an area of an inner side of the laminate.

In still another embodiment, a coating incidence angle θ_{c} of the enhanced p-polarized reflective coating is selected such that an incidence angle θ_{b} at the first is the Brewster's angle for the glass to air interface.

In still another embodiment, the present invention relates to a laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and a first coating positioned over at least a portion of the fourth surface, wherein the first coating comprises a first high refractive index layer positioned over at least a portion of the fourth surface of the second ply; a first low refractive index layer positioned over at least a portion of the first high refractive index layer; a second high refractive index layer positioned over at least a portion of the first low refractive index layer; and a second low refractive index layer positioned over at least a portion of the second high refractive index layer, wherein the laminate has a p-polarized reflection, as determined at an angle of 70 degrees (rather than 60 degrees as shown with regard to FIG. 7) relative to the normal of the laminate, of at least 37, at least 38, or even at least 40 percent of the p-polarized radiation at one or more wavelengths of at least 450 nm, 530 nm, and/or 620 nm. In still another embodiment, the laminate further comprises a second coating as described herein that is positioned over at least a portion of the second surface or the third surface and that functions as, in one embodiment, a solar control coating.

In still another embodiment, the laminate of this embodiment has a maximum reflectance of unpolarized light as determined at an angle of 70 degrees relative to the normal of the laminate of less than 28 percent, less than 27 percent, less than 26 percent, or even less than 25 percent at at least a wavelength of 550 nm.

In still another embodiment, when the laminate of this embodiment is applied to one side of a glass substrate the RfY for unpolarized light, as determined by the D65 testing procedure described below, is below 26 percent while the p-polarized radiation reflectance, as also determined by the D65 testing procedure described below at at least a wavelength of 550 nm, is at least 40 percent at one or more wavelengths of at least 450 nm, 530 nm, and/or 620 nm. In still another embodiment, when the laminate of this embodiment is applied to one side of a glass substrate the p-polarized radiation reflectance, as determined by the D65 testing procedure described below, is at least 40 percent in the wavelength range of at 450 nm to 620 nm.

In this four layer embodiment, the first high refractive index layer positioned over at least a portion of the fourth surface of the second ply is formed from titania (also referred to as titanium dioxide) and has a thickness in the range of 75 Å and 650 Å, or in the range of 100 Å to 600 Å, or in the range of 125 Å to 575 Å, or in the range of 150 Å to 550 Å, or in the range of 175 Å to 500 Å, or even in the range of 180 Å to 225 Å. In another embodiment, this first high refractive index layer is formed from any suitable material that comprises a refractive index of 1.91 to 2.2.

In this four layer embodiment, the first low refractive index layer positioned over at least a portion of the first high refractive index layer is formed from silica, alumina, or silica-alumina and has a thickness in the range of 175 Å and 650 Å, or in the range of 200 Å to 600 Å, or in the range of 225 Å to 575 Å, or in the range of 250 Å to 550 Å, or in the range of 275 Å to 500 Å, or even in the range of 300 Å to 400 Å. In another embodiment, the first low refractive index layer positioned over at least a portion of the first high refractive index layer is formed from a silica-alumina composition having 85 weight percent silica to 15 weight percent alumina. It should be noted that this layer of this four layer embodiment is not limited to just this mixture of silica and alumina in this first low refractive index layer. Rather, any of the other suitable silica-alumina layer compositional make-ups described here could be used in place of this 85-15 silica-alumina layer such as any amount of silica to alumina in the weight range of 50-50 to 95-5 silica to alumina. It should be noted that in one embodiment, this layer of this four layer embodiment is manufactured in a manner and/or atmosphere so as to produce a silica-alumina oxide layer. In another embodiment, this first low refractive index layer is formed from any suitable material that comprises a refractive index of 1.4 to 1.6.

In this four layer embodiment, the second high refractive index layer positioned over at least a portion of the first low refractive index layer is formed from metallic silicon (or elemental silicon) via the deposition of a 90 weight percent silicon to 10 weight percent aluminum layer under a non-oxidizing atmosphere such as an argon atmosphere. It should be noted that this layer of this four layer embodiment is not limited to just this mixture of silicon and aluminum. Rather, any of the other suitable silicon and aluminum compositional make-ups could be used in place of this 90/10 silicon-aluminum layer such as any amount of silicon to aluminum in the weight range of 85-15 to 97-3 silicon to aluminum so long as this layer is formed under a non-oxidizing atmosphere such as an argon atmosphere. In one embodiment, this second high refractive index layer has a thickness in the range of 250 Å and 400 Å, or in the range of 275 Å to 375 Å, or in the range of 300 Å to 350 Å, or even in the range of 310 Å to 340 Å. In another embodiment, this second high refractive index layer is formed from any suitable material that comprises a refractive index of 1.91 to 4. In still another embodiment, this second high refractive index layer is a very high refractive layer and formed from any suitable material that comprises a refractive index of 2.4 to 4, or 2.5 to 3.9, or even 2.7 to 3.7.

In still another embodiment, when the second high refractive index layer is a very high refractive layer, such a layer can alternatively be formed from just silicon (or even metallic silicon or elemental silicon) so long as this layer is formed under a non-oxidizing atmosphere such as an argon atmosphere, boron-doped silicon, or even gallium arsenide.

In this four layer embodiment, the second low refractive index layer positioned over at least a portion of the second high refractive index layer (or very high refractive layer) is formed from silica, alumina, or silica-alumina and has a thickness in the range of 800 Å and 1350 Å, or in the range of 850 Å to 1300 Å, or in the range of 900 Å to 1250 Å, or even in the range of 950 Å to 1200 Å. In another embodiment, the second low refractive index layer positioned over at least a portion of the second high refractive index layer (or very high refractive layer) is formed from a silica-alumina composition having 85 weight percent silica to 15 weight percent alumina. It should be noted that this layer of this four layer embodiment is not limited to just this mixture of silica and alumina in this first low refractive index layer. Rather, any of the other suitable silica-alumina layer compositional make-ups described here could be used in place of this 85-15 silica-alumina layer such as any amount of silica to alumina in the weight range of 50-50 to 95-5 silica to alumina. It should be noted that in one embodiment, this layer of this four layer embodiment is manufactured in a manner and/or atmosphere so as to produce a silica-alumina oxide layer. In another embodiment, this first low refractive index layer is formed from any suitable material that comprises a refractive index of 1.4 to 1.6.

It should be noted that this four layer embodiment can further comprise one or more of a protective layer, a topcoat layer, and/or an overcoat layer as described herein, where such one or more layers are all located on top of and above the second low refractive index layer.

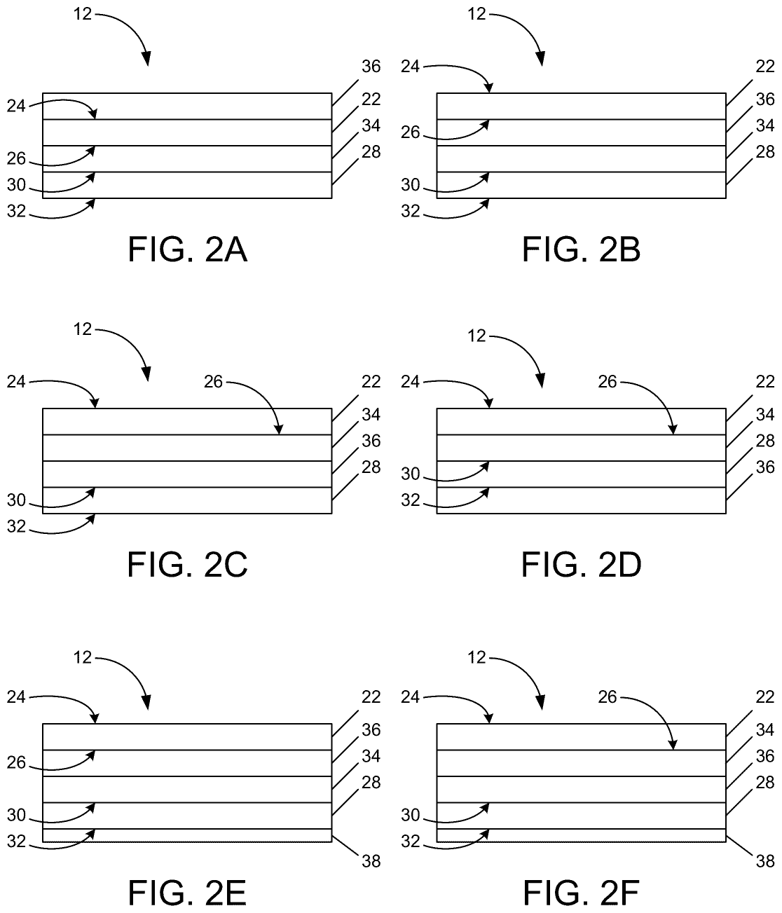

Given the above, it should be noted that any of the above laminates can be used in place of any of the laminates described below with regard to FIGS. 2A-2F, 3A, 3B, 4A, 4B, 5A,5B, and/or 6 to achieve an enhanced p-polarized reflective coating described below. As will be described below, in another embodiment both the first coating positioned on at least a portion of the fourth surface of the second ply (as described herein) and the second coating positioned on at least a portion of the second surface or third surface (as described herein) can be used together, where the first coating acts as an enhanced p-polarized reflective coating and the second coating acts as a solar control coating.

### Display System

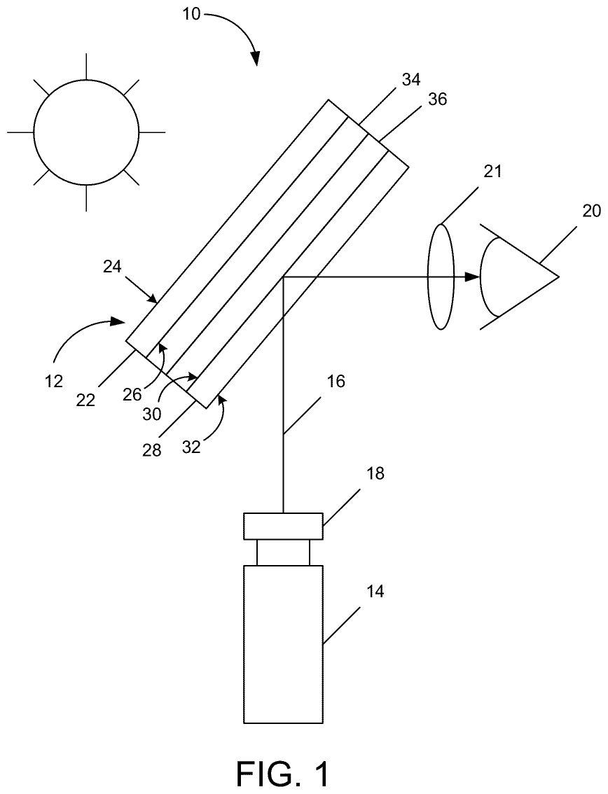

Referring to FIG. 1, a display system 10 according to the present invention is shown. Display system 10 can be a heads-up display (HUD) in a vehicle, such as a heads-up display in an automobile or aircraft. However, display system 10 is not limited to heads-up displays in vehicles, and can be any type of display projecting an image. Non-limiting examples of displays that can be considered the “display system” include advertising, promotional, or informational displays, and the like. Display system 10 may project an image visible to humans (e.g., within the visible spectrum). Alternatively, display system 10 may project an image in a non-visible region of the electromagnetic spectrum.

With continued reference to FIG. 1, display system 10 includes a laminate 12 and a radiation source 14. Radiation source 14 can emit electromagnetic radiation 16, or any other desired form of radiation. Radiation source 14 can emit radiation 16 across the entire radiation spectrum, or across only a portion thereof (e.g., across the visible spectrum, ultra violet radiation, infrared radiation, and the like, as well as combinations thereof). Radiation source 14 can emit white light as radiation 16. Radiation 16 can include s-polarized radiation and/or p-polarized radiation. By “s-polarized radiation” it is meant that radiation 16 has an electric field normal to the plane of incidence. By “p-polarized radiation” it is meant that radiation 16 has an electric field along the plane of incidence. “Angle of incidence” is defined as the angle between a ray of radiation incident on a surface to a line normal to the surface at the point of incidence. Radiation source 14 can emit radiation 16 directed at laminate 12 such that radiation 16 contacts laminate 12 at at least one point.

With continued reference to FIG. 1, display system 10 can further include a polarized filter 18. Polarized filter 18 can be positioned between radiation source 14 and laminate 12. Polarized filter 18 can be designed to permit at least a portion of the p-polarized and/or the s-polarized radiation to pass therethrough. Polarized filter 18 can alternatively be designed to permit only p-polarized radiation to pass therethrough. Polarized filter 18 can be designed to filter at least a portion of the s-polarized radiation, such that the filtered portion cannot pass therethrough. Polarized filter 18 can further, or alternatively, be designed to filter substantially all of the s-polarized radiation, such that substantially all of the s-polarized radiation cannot pass therethrough. Substantially all, in this context, means that polarized filter 18 filters at least 95 percent of the s-polarized radiation, such as at least 97 percent, at least 99 percent, or 100 percent of the s-polarized radiation.

With continued reference to FIG. 1, radiation source 14 can emit radiation 16 that is directed off of laminate 12, such that at least a portion of radiation 16 is reflected off of laminate 12 and is directed to an eye 20 of a user. The portion of the radiation not reflected off of laminate 12, can be refracted, absorbed, or otherwise transmitted through laminate 12. The user may be wearing polarized sunglasses 21, and radiation 16 that is directed to the eye 20 of the user may be directed toward polarized sunglasses 21. In one non-limiting embodiment, polarized sunglasses 21 can filter s-polarized radiation such that at least a portion of the s-polarized radiation cannot pass therethrough.

With continued reference to FIG. 1, when radiation source 14 emits radiation 16 directed at laminate 12, an image can be projected to an area on an inner side of laminate 12, and the image can be viewable to eye 20 of a user. The image of display system 10 can be static or dynamic. The image can include colors and can be a monochromatic image or a polychromatic image. The image can be an image in a HUD. The HUD can be a HUD in an automobile or other vehicle. In this example, laminate 12 can be a windshield, or other laminate 12 in a vehicle, and radiation source 14 can be directed at laminate 12 to display an image so that the driver (or other user) may see the image while operating the vehicle.

### Laminate

Referring to FIG. 1 and FIGS. 2A-2F, various examples of laminate 12 of the present invention are shown. Laminate 12 can include a first ply 22 having a first surface 24 (No. 1 surface) and an opposite second surface 26 (No. 2 surface). Laminate 12 can also include a second ply 28 having a third surface 30 (No. 3 surface) and an opposite fourth surface 32 (No. 4 surface). This numbering of the surfaces is in keeping with standard practice in the art. Second surface 26 can be facing third surface 30, and an interlayer 34 can be positioned between second surface 26 and third surface 30. Referring to FIG. 1, first surface 24 can be an outer surface of laminate 12, and fourth surface 32 can be an inner surface of laminate 12. In the case of laminate 12 being a windshield of a vehicle, first surface 24 can be the surface closest to the sun, while fourth surface 32 can be the surface closest to an interior of the vehicle. In this way, fourth surface 32 can be the surface of laminate 12 closest to radiation source 14 positioned inside the vehicle and directed at laminate 12.

First ply 22 and/or second ply 28 can be transparent or translucent to visible radiation. By “transparent” is meant having visible radiation transmittance of greater than 0 percent up to 100 percent. Alternatively, the ply can be translucent. By “translucent” is meant diffusing visible radiation such that objects on the side opposite a viewer are not clearly visible. Examples of suitable materials include, but are not limited to, plastic substrates (such as acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxane-containing polymers; or copolymers of any monomers for preparing these, or any mixtures thereof); ceramic substrates; glass substrates; or mixtures or combinations of any of the above. For example, plies 22 and/or 28 can include conventional soda-lime-silicate glass, borosilicate glass, or leaded glass. The glass can be clear glass. By “clear glass” is meant non-tinted or non-colored glass. Alternatively, the glass can be tinted or otherwise colored glass. The glass can be annealed or heat-treated glass. As used herein, the term “heat treated” means tempered or at least partially tempered. The glass can be of any type, such as conventional float glass, and can be of any composition having any optical properties, e.g., any value of visible radiation transmittance, ultraviolet radiation transmittance, infrared radiation transmittance, and/or total solar energy transmittance. By “float glass” is meant glass formed by a conventional float process in which molten glass is deposited onto a molten metal bath and controllably cooled to form a float glass ribbon.

First ply and/or second ply 22 and/or 28 can be, for example, clear float glass or can be tinted or colored glass. Plies 22 and/or 28 can be of any desired dimensions, e.g., length, width, shape, or thickness. Non-limiting examples of glass that can be used for the practice of the invention include clear glass, Starphire®, Solargreen®, Solextra®, GL-20®, GL-35™ Solarbronze®, Solargray® glass, Pacifica® glass, SolarBlue® glass, and Optiblue® glass, all commercially available from Vitro Architectural Glass of Pittsburgh, Pennsylvania.

The other of first ply 22 and second ply 28 can be of any of the materials described above for first ply 22 and/or second ply 28. First ply 22 and second ply 28 can be the same or different from one another. First and second plies 22 and/or 28 can each be, for example, clear float glass or can be tinted or colored glass or one ply 22 and/or 28 can be clear glass and the other ply 22 and/or 28 colored glass.

With continued reference to FIGS. 2A-2F, laminate 12 can also include an enhanced p-polarized reflective coating 36 positioned over at least a portion of one of surfaces 24, 26, 30, and/or 32 of plies 22 and/or 28. In FIG. 2A, enhanced p-polarized reflective coating 36 is positioned over first surface 24. In FIG. 2B, enhanced p-polarized reflective coating 36 is positioned over second surface 26. In FIG. 2C, enhanced p-polarized reflective coating 36 is positioned over third surface 30. In FIG. 2D, enhanced p-polarized reflective coating 36 is positioned over fourth surface 32.

With continued reference to FIGS. 2E-2F, laminate 12 can include further coating layers beyond enhanced p-polarized reflective coating 36. Laminate 12 can include an anti-reflective coating 38 positioned over one of surfaces 24, 26, 30, and/or 32 of plies 22 and/or 28. As shown in FIGS. 2E and 2F, anti-reflective coating 38 can be positioned over fourth surface 32 when enhanced p-polarized reflective coating 36 is positioned over second surface 26 (FIG. 2E) or third surface 30 (FIG. 2F).

### Enhanced P-Polarized Reflective Coating

As noted above, any of the above laminates disclosed herein can be used in place of any of the laminates described below to achieve an enhanced p-polarized reflective coating described below. In another embodiment, the following enhanced p-polarized reflective coating can be the second coating described herein, and can be used as a solar control coating when combined with the fourth surface first coating described above.

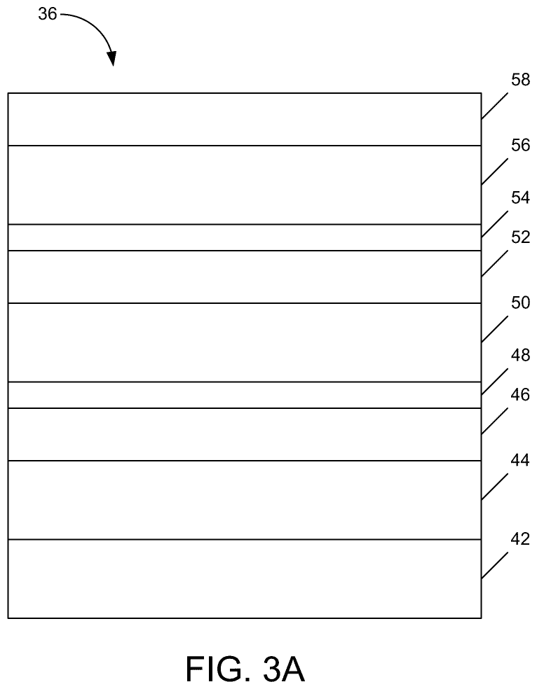

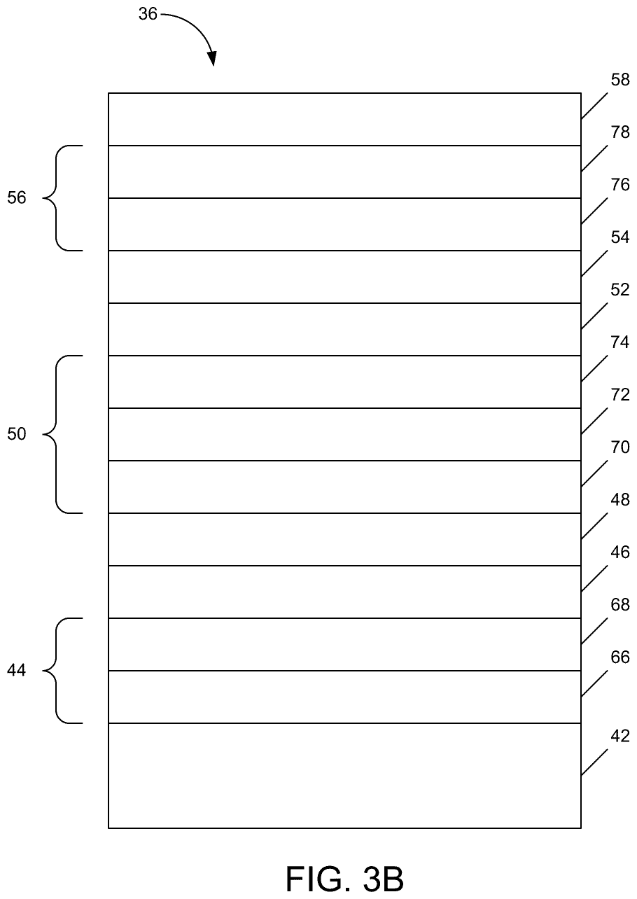

Referring to FIGS. 3A and 3B, enhanced p-polarized reflective coating 36 can be a double metal functional layer enhanced p-polarized reflective coating 36. In the double metal functional layer enhanced p-polarized reflective coating 36, a base layer 44 can be positioned over a substrate 42 (substrate 42 being one of previously described surfaces 24, 26, 30, and/or 32). A first metal functional layer 46 can be positioned over base layer 44. A first primer layer 48 (alternatively, throughout this specification, the one or more primer layers can be referred to as one or more sacrificial metal layers) can be positioned over first metal functional layer 46. A first phase adjustment layer 50 can be positioned over first primer layer 48. A second metal functional layer 52 can be positioned over first phase adjustment layer 50. A second primer layer 54 can be positioned over second metal functional layer 52. A topcoat layer 56 can be positioned over second primer layer 54. An overcoat 58 can be positioned over topcoat layer 56.

Referring to FIG. 3B, at least one of the layers in enhanced p-polarized reflective coating 36 of the double metal functional layer enhanced p-polarized reflective coating 36 can include multiple layers. Base layer 44 can include a first film 66 and a second film 68. First film 66 can be positioned over substrate 42, and second film 68 can be positioned over first film 66. First phase adjustment layer 50 can include a first film 70, a second film 72, and a third film 74. First film 70 can be positioned over first primer layer 48. Second film 72 can be positioned over first film 70, and third film 74 can be positioned over second film 72. Topcoat layer 56 can include a first film 76 and a second film 78. First film 76 can be positioned over second primer layer 54, and second film 78 can be positioned over first film 76.

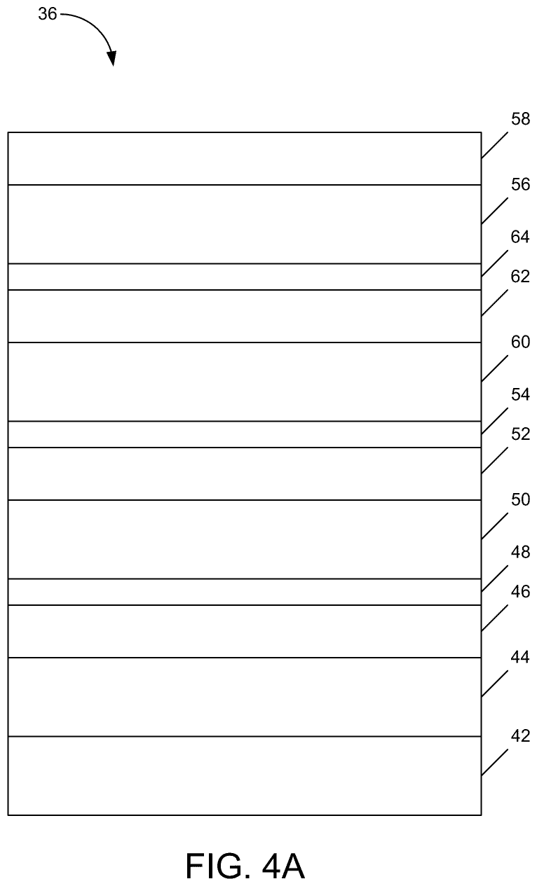

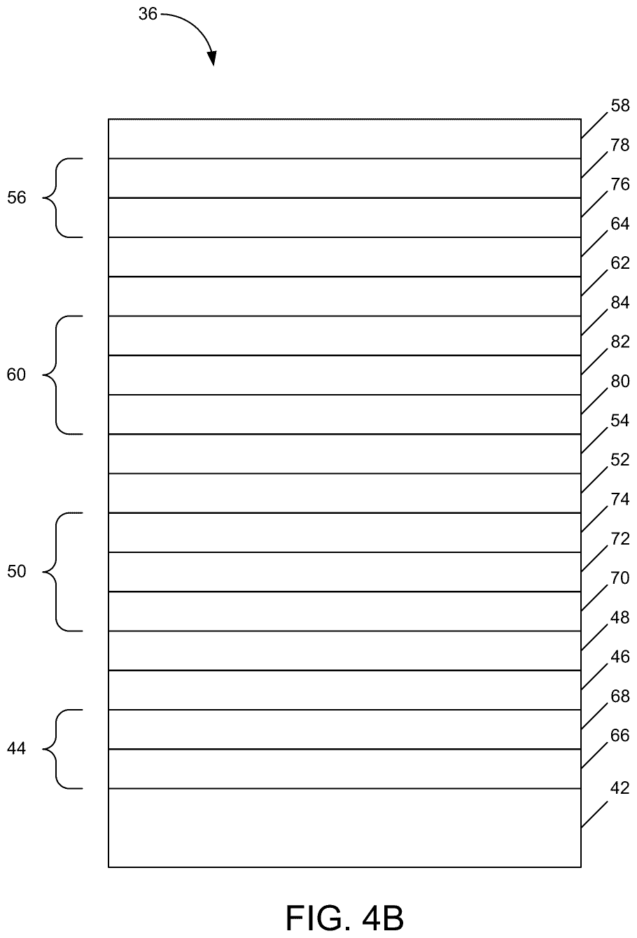

Referring to FIGS. 4A and 4B, enhanced p-polarized reflective coating 36 can be a triple metal functional enhanced reflective coating 36, which includes several additional layers compared to the double metal functional layer enhanced p-polarized reflective coating 36 of FIGS. 3A and 3B. The triple metal functional enhanced p-polarized reflective coating 36 can further include (compared to the double metal functional layer enhanced p-polarized reflective coating 36) a second phase adjustment layer 60 positioned over second primer layer 54. A third metal functional layer 62 can be positioned over second phase adjustment layer 60. A third primer layer 64 can be positioned over third metal functional layer 62. Topcoat layer 56 and overcoat layer 58 (previously described) can be positioned over third primer layer 64.

Referring to FIG. 4B, at least one of the layers in enhanced p-polarized reflective coating 36 of the triple metal functional layer enhanced p-polarized reflective coating 36 can include multiple layers. In addition to those described in the double metal functional layer enhanced p-polarized reflective coating 36 (FIG. 3B), second phase adjustment layer 60 of the triple metal functional layer enhanced p-polarized reflective coating 36 can have multiple layers. Second phase adjustment layer 60 can include a first film 80, a second film 82, and a third film 84. First film 80 can be positioned over second primer layer 54. Second film 82 can be positioned over first film 80, and third film 84 can be positioned over second film 82. In multi-layer topcoat layer 56 previously described, first film 76 can be positioned over third primer layer 64.

Based on this disclosure, it will be appreciated that further repeating coating units are within the scope of the invention. For example, adding additional phase adjustment layers, metal functional layers, and/or primer layers (e.g., to form quadruple, quintuple, and the like, metal functional layer enhanced p-polarized reflective coatings 36) is also contemplated by this disclosure.

Enhanced p-polarized reflective coating 36 can be an electro-conductive low emissivity coating that allows visible wavelength energy to be transmitted through the coating but reflects longer wavelength solar infrared energy. By “low emissivity” is meant emissivity less than 0.4, such as less than 0.3, such as less than 0.2, such as less than 0.1, e.g., less than or equal to 0.05.

In one embodiment, enhanced p-polarized reflective coating 36, when applied to substrate 42, can make substrate 42 neutral in color such that the reflectivity for color value a* and/or b* is between −2 and 2, in accordance with 1976 CIELAB color system specified by the International Commission on Illumination. In another embodiment, the laminates of the present invention can have various other optical, color, and/or light reflecting properties as described herein. Substrate 42 can have a low exterior reflectance, such that the reflectance is less than or equal to 30 percent, such as less than or equal to 15 percent, when observing substrate 42 from an angle normal to substrate 42.

Enhanced p-polarized reflective coating 36 can be deposited on substrate 42 by any conventional method. Examples of such methods include conventional chemical vapor deposition (CVD) and/or physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as, but not limited to, sol-gel deposition. In one non-limiting embodiment, enhanced p-polarized reflective coating 36 can be deposited by MSVD.

Enhanced p-polarized reflective coating 36 can be deposited over a portion of or the entire surface of substrate 42. In some examples, enhanced p-polarized reflective coating 36 can be deposited over a first larger region of substrate 42 and then a portion of the first larger region can be “deleted” so that enhanced p-polarized reflective coating 36 is positioned over a second smaller region, which is a sub-region of the first larger region.

### Base Layer

Base layer 44 can include a nonmetallic layer(s). For example, base 44 layer can include dielectric or semiconductor materials. For example, base layer 44 can include oxides, nitrides, oxynitrides, and/or mixtures thereof. Examples of suitable materials for base layer 44 can include oxides, nitrides, or oxynitrides of titanium, hafnium, zirconium, niobium, zinc, bismuth, lead, indium, tin, and mixtures thereof. These may have small amounts of other materials, such as manganese in bismuth oxide, tin in indium oxide, etc. Additionally, oxides of metal alloys or metal mixtures can be used, such as oxides containing zinc and tin (e.g., zinc stannate), oxides of indium-tin alloys, silicon nitrides, silicon aluminum nitrides, or aluminum nitrides. Further, doped metal oxides, such as antimony or indium doped tin oxides or nickel or boron doped silicon oxides, can be used. Particular examples of materials include zinc oxides, tin oxides, silicon nitrides, silicon-aluminum nitrides, silicon-nickel nitrides, silicon-chromium nitrides, antimony doped tin oxide, aluminum doped zinc oxide, indium doped zinc oxide, titanium oxide, and/or mixtures thereof. Base layer 44 can include a single material. Alternatively, base layer 44 can include multiple materials and/or multiple layers.

Base layer 44 can allow adjustment of the constructive and destructive optical interference of electromagnetic radiation partially reflected from, and/or partially transmitted by, the various interface boundaries of the layers of enhanced p-polarized reflective coating 36. Additionally, base layer 44 can provide chemical and/or mechanical protection for other layers of enhanced p-polarized reflective coating 36, such as metal functional layers 46, 52, and/or 62.

Where high visible light transmittance is desired, base layer 44 can act as an antireflective layer to anti-reflect metal functional layers 46, 52, and/or 62 to reduce the overall visible light reflectance and/or increase the visible light transmittance of enhanced p-polarized reflective coating 36. Materials having refractive indices around 2 are particularly useful for anti-reflection of metal functional layers 46, 52, and/or 62.

In the illustrated exemplary enhanced p-polarized reflective coating 36, base layer 44 can be positioned over at least a portion of substrate 42 (which can be one of surfaces 24, 26, 30, and/or 32 of one of plies 22 and/or 28). Base layer 44 can be a single layer or can include one or more films of anti-reflective materials and/or dielectric materials described above. Base layer 44 can be transparent to visible light.

As discussed above, base layer 44 can include a metal oxide, a mixture of metal oxides, and/or a metal alloy oxide. For example, base layer 44 can include oxides of zinc and tin.

Base layer 44 can have a thickness in the range of 300-550 Å. For example, base layer 44 can have a thickness in the range of 300-500 Å; 350-430 Å or 375-430 Å. For example, base layer 44 can have a thickness in the range of 350-550 Å, 400-500 Å; or 420-490 Å.

Base layer 44 can include a multi-film structure having a first film 66 and/or a second film 68. First film 66 can be, e.g., a metal alloy oxide film. Second film 68 can be, e.g., a metal oxide film or an oxide mixture film. Second film 68 can be positioned over first film 66.

First film 66 can be a zinc/tin alloy oxide. By “zinc/tin alloy oxide” is meant both true alloys and also mixtures of the oxides. The zinc/tin alloy oxide can be that obtained from magnetron sputtering vacuum deposition from a cathode of zinc and tin. The cathode can include zinc and tin in proportions of 5 weight percent to 95 weight percent zinc and 95 weight percent to 5 weight percent tin, such as 10 weight percent to 90 weight percent zinc and 90 weight percent to 10 weight percent tin. However, other ratios of zinc to tin could also be used. An exemplary metal alloy oxide for first film −66 can be written as Zn_{X}Sn_{1-X}O_{2-X} (Formula 1) where “x” varies in the range of greater than 0 to less than 1. For instance, “x” can be greater than 0 and can be any fraction or decimal between greater than 0 to less than 1. The stoichiometric form of Formula 1 is “Zn₂SnO₄”, commonly referred to as zinc stannate. A zinc stannate layer can be sputter deposited from a cathode having 52 weight percent zinc and 48 weight percent tin in the presence of oxygen. For example, first film 66 can include zinc stannate.

Second film 68 can include a metal oxide film. For example, second film 68 can include zinc oxide. The zinc oxide can be deposited from a zinc cathode that includes other materials to improve the sputtering characteristics of the cathode. For example, the zinc cathode can include a small amount of tin (e.g., up to 10 weight percent, such as up to 5 weight percent) to improve sputtering. Thus, the resultant zinc oxide film can include a small percentage of tin oxide, e.g., up to 10 weight percent tin oxide, e.g., up to 5 weight percent tin oxide. A coating layer deposited from a zinc cathode having up to 10 weight percent tin is referred to herein as “a zinc oxide film” even though a small amount of tin oxide (e.g., up to 10 weight percent) can be present. The tin in the cathode is believed to form tin oxide in the predominantly zinc oxide second film 68.

### Metal Functional Layers

At least one of metal functional layers 46, 52, and/or 62 can be a continuous metal layer. By “continuous” metal layer is meant an unbroken or non-disconnected layer, such as a homogeneous layer.

Metal functional layers 46, 52, and/or 62 provide reflectance of electromagnetic radiation in at least a portion of the infrared radiation region of the electromagnetic spectrum, for example, in the solar infrared radiation region and/or the thermal infrared radiation region of the electromagnetic spectrum.

Examples of materials useful for metal functional layers 46, 52, and/or 62 include noble or near noble metals. Examples of such metals include silver, gold, platinum, palladium, osmium, iridium, rhodium, ruthenium, copper, mercury, rhenium, aluminum, and combinations thereof. For example, one or more of metal functional layers 46, 52, and/or 62 can include metallic silver.

First metal functional layer 46 can be positioned over base layer 44 and can include any of the above metals. For example, first metal functional layer 46 can include silver. First metal functional layer 46 can be a continuous layer.

First metal functional layer 46 can be a continuous layer having a thickness in the range of 10-200 Å. For example, first metal functional layer 46 can have a thickness in the range of 10-200 Å or 50-150 Å. For example, first metal functional layer 46 can have a thickness in the range of 10-150 Å or 50-125 Å. Second metal functional layer 52 can be positioned over first phase adjustment layer 50. Second metal functional layer 52 can be a continuous layer including silver.

Second metal functional layer 52 can be a continuous layer having a thickness in the range of 10-150 Å. For example, second metal functional layer 52 can have a thickness in the range of 10-150 Å or 50-125 Å. For example, second metal functional layer 52 can have a thickness in the range of 10-100 Å; 50-75 Å or 65-75 Å.

Third metal functional layer 62 can include any of the materials discussed above with respect to first or second metal functional layers 46, 52. For example, third metal functional layer 62 can include silver. Third metal functional layer 62 can be a continuous layer positioned over second phase adjustment layer 60. For example, third metal functional layer 62 can be a continuous layer having a thickness in the range of 50-200 Å; 75-150 Å or 60-140.

Metal functional layer 46, second metal functional layer 52 and optional third metal functional layer 62 have a combined thickness. The combined thickness can be in the range of 100-350 Å; or 150-300 Å or 175-275 Å. In embodiments that only comprise first and second metal functional layers 46 and 52, the combined thickness can be in the range of 150-250 Å, 175-225 Å; 175-215 Å; or 178-211 Å. For embodiments that comprise first, second and third metal functional layers 46, 52, and 62, the combined thickness can be in the range of 225-325 Å, 240-300 Å, 250-280 Å, or 253-275 Å.

### Primer Layers

Primer layers 48, 54, and/or 64 can be positioned in direct contact with the associated underlying metal functional layer 46, 52, and/or 62. Primer layers 48, 54, and/or 64 can protect associated metal functional layers 46, 52, and/or 62 during the coating process and/or subsequent processing, such as thermal tempering. Primer layer 48, 54, and/or 64 can be deposited as a metal. During subsequent processing, such as the deposition of overlying phase adjustment layer 50 and/or 60 or topcoat layer 56 and/or thermal tempering, some or all of primer layer 48, 54, and/or 64 may oxidize. When oxide or nitride materials are used in overlying phase adjustment layer 50 and/or 60 or topcoat layer 56, primer layer 48, 54, and/or 64 can include oxophillic or nitrophillic materials, respectively. Primer layers 48, 54, and/or 64 need not be all the same material. Primer layers 48, 54, and/or 64 need not be of the same thickness.

Examples of materials useful for primer layers 48, 54, and/or 64 include titanium, niobium, tungsten, nickel, chromium, iron, tantalum, zirconium, aluminum, silicon, indium, tin, zinc, molybdenum, hafnium, bismuth, vanadium, manganese, and combinations thereof.

First primer layer 48 can be positioned over first metal functional layer 46. First primer layer 48 can be a single film or a multiple film layer. First primer layer 48 can include any of the materials described above. For example, first primer layer 48 can include titanium.

Second primer layer 54 can be positioned over second metal functional layer 52. Second primer layer 54 can be of any of the materials as described above with respect to first primer layer 48. For example, second primer layer 54 can include titanium.

Third primer layer 64 can be positioned over third metal functional layer 62. Third primer layer 64 can be of any of the materials as described above with respect to first or second primer layer 48, 54. For example, third primer layer 64 can include titanium.

Primer layers 48, 54, and/or 64 can have the same or a different thickness in the range of 10-50 Å, such as 20-40 Å, or even 25-35 Å. The thickness of the primer layers can be chosen to provide sufficient protection to the underlying metal functional layer (e.g., such that the sacrificial metals preferably oxidize to protect the underlying metal functional layer during deposition of overlaying layers).

### Phase Adjustment Layers

Phase adjustment layers 50 and/or 60 can be nonmetallic layers. For example, phase adjustment layers 50 and/or 60 can include dielectric or semiconductor materials. For example, phase adjustment layers 50 and/or 60 can include oxides, nitrides, oxynitrides, and/or mixtures thereof. Examples of suitable materials for phase adjustment layers 50 and/or 60 can include oxides, nitrides, or oxynitrides of titanium, hafnium, zirconium, niobium, zinc, bismuth, lead, indium, tin, and mixtures thereof. These may have small amounts of other materials, such as manganese in bismuth oxide, tin in indium oxide, etc. Additionally, oxides of metal alloys or metal mixtures can be used, such as oxides containing zinc and tin (e.g., zinc stannate), oxides of indium-tin alloys, silicon nitrides, silicon aluminum nitrides, or aluminum nitrides. Further, doped metal oxides, such as antimony or indium doped tin oxides or nickel or boron doped silicon oxides, can be used. Particular examples of materials include zinc oxides, tin oxides, silicon nitrides, silicon-aluminum nitrides, silicon-nickel nitrides, silicon-chromium nitrides, antimony doped tin oxide, aluminum doped zinc oxide, indium doped zinc oxide, titanium oxide, and/or mixtures thereof.

Phase adjustment layers 50 and/or 60 can include a single material. Alternatively, phase adjustment layers 50 and/or 60 can include multiple materials and/or multiple layers. The different phase adjustment layers 50 and/or 60 can include the same or different materials. Phase adjustment layers 50 and/or 60 can have the same or different thicknesses.

Phase adjustment layers 50 and/or 60 can allow adjustment of the constructive and destructive optical interference of electromagnetic radiation partially reflected from, and/or partially transmitted by, the various interface boundaries of the layers of enhanced p-polarized reflective coating 36. Varying the thicknesses and/or compositions of phase adjustment layers 50 and/or 60 can change the overall reflectance, transmittance, and/or absorptance of enhanced p-polarized reflective coating 36, which can alter the solar control performance, thermal infrared insulating performance, color, and/or aesthetics of enhanced p-polarized reflective coating 36. Additionally, phase adjustment layers 50 and/or 60 can provide chemical and/or mechanical protection for other layers of enhanced p-polarized reflective coating 36, such as metal functional layers 46, 52, and/or 62.

Where high visible light transmittance is desired, phase adjustment layers 50 and/or 60 can act as anti-reflective layers to anti-reflect metal functional layers 46, 52, and/or 62 to reduce the overall visible light reflectance and/or increase the visible light transmittance of enhanced p-polarized reflective coating 36. Materials having refractive indices around 2 are particularly useful for anti-reflection of metal functional layers 46, 52, and/or 62.

First phase adjustment layer 50 can be positioned over first primer layer 48. First phase adjustment layer 50 can include one or more of the materials and/or films described above.

First phase adjustment layer 50 can have a thickness in the range of 600-1,100 Å. For example, first phase adjustment layer 50 can have a thickness in the range of 700-1,100 Å, such as 850-1,050 Å, such as 675-1050 Å or such as 689-1048 Å. For example, first phase adjustment layer 50 can have a thickness in the range of 600-1,000 Å, such as 675-875 Å, or such as 689-866 Å. For example, first phase adjustment layer 50 can have a thickness in the range of 825-1100 Å, such as 850-1075 Å, such as 875-1050 Å, such as 879-1048 Å.

First phase adjustment layer 50 can be a single layer or a multilayer structure. For example, first phase adjustment layer 50 can include a first film 70, a second film 72, and a third film 74. For example, first film 70 can include a metal oxide film. For example, first film 70 can include a zinc oxide film.

For example, second film 72 can include a metal alloy oxide film. For example, second film 72 can include a zinc stannate film. For example, third film 74 can include a metal oxide film. For example, third film 74 can include a zinc oxide film. An optional second phase adjustment layer 60 can be positioned over second primer layer 54. Second phase adjustment layer 60 can include any of the materials and/or layers as discussed above with respect to first phase adjustment layers 50. For example, second phase adjustment layer 60 can be a multi-film structure. For example, second phase adjustment layer 60 can include a first film 80, a second film 82, and a third film 84. Second phase adjustment layer 60 can have a thickness in the range of 500-1,000 Å, such as 600-825 Å or such as 619-817 Å.

First film 80 can include a metal oxide layer, for example, a zinc oxide layer. Second film 82 can include a metal alloy oxide material, for example, zinc stannate. Third film 84 can include a metal oxide layer, for example, a zinc oxide layer.

### Topcoat Layer

Topcoat layer 56 can include one or more materials and/or layers as discussed above with respect to first or second phase adjustment layers 50 and/or 60. Topcoat layer 56 can have a thickness in the range of 300-450 Å. Topcoat layer 56 can have a thickness in the range of 300-400 Å or 340-375 Å. Topcoat layer 56 can have a thickness in the range of 275-450 Å or 300-415 Å or 311-411 Å or 346-368 Å. Topcoat layer 56 can include a first film 76 and a second film 78. First film 76 can include a metal oxide layer, for example, a zinc oxide layer. Second film 78 can include a metal-alloy oxide layer, for example, a zinc stannate layer.

### Overcoat

Enhanced p-polarized reflective coating 36 can include an overcoat 58 positioned over topcoat layer 56. Overcoat 58 can be deposited over topcoat layer 56 to assist in protecting the underlying layers from mechanical and chemical attack during processing. Overcoat 58 can be an oxygen barrier coating layer to prevent or reduce the passage of ambient oxygen into the underlying layers of enhanced p-polarized reflective 36, such as during heating or bending. Overcoat 58 can be of any desired material or mixture of materials. In one exemplary embodiment, overcoat 58 can include a layer having one or more metal oxide materials, such as but not limited to oxides of aluminum, silicon, or mixtures thereof (e.g., be a silica and alumina coating). For example, overcoat 58 can be a single coating layer including in the range of 0 weight percent to 100 weight percent alumina and/or 100 weight percent to 0 weight percent silica, such as 5 weight percent to 95 weight percent alumina and 95 weight percent to 5 weight percent silica, such as 10 weight percent to 90 weight percent alumina and 90 weight percent to 10 weight percent silica, such as 15 weight percent to 90 weight percent alumina and 85 weight percent to 10 weight percent silica, such as 50 weight percent to 75 weight percent alumina and 50 weight percent to 25 weight percent silica, such as 50 weight percent to 70 weight percent alumina and 50 weight percent to 30 weight percent silica, such as 35 weight percent to 100 weight percent alumina and 65 weight percent to 0 weight percent silica, e.g., 70 weight percent to 90 weight percent alumina and 30 weight percent to 10 weight percent silica, e.g., 75 weight percent to 85 weight percent alumina and 25 weight percent to 15 weight percent of silica, e.g., 88 weight percent alumina and 12 weight percent silica, e.g., 65 weight percent to 75 weight percent alumina and 35 weight percent to 25 weight percent silica, e.g., 70 weight percent alumina and 30 weight percent silica, e.g., 60 weight percent to less than 75 weight percent alumina and greater than 25 weight percent to 40 weight percent silica. Overcoat 58 can be a single coating layer including 85 weight percent silica and 15 weight percent alumina. Other materials, such as aluminum, chromium, hafnium, yttrium, nickel, boron, phosphorous, titanium, zirconium, and/or oxides thereof, can also be present, such as to adjust the refractive index of overcoat 58. In one non-limiting example, the refractive index of overcoat 58 can be in the range of 1 to 3, such as 1 to 2, or such as 1.4 to 2, such as 1.4 to 1.8.

Overcoat 58 can be a combination silica and alumina coating. Overcoat 58 can be sputtered from two cathodes (e.g., one silicon and one aluminum) or from a single cathode containing both silicon and aluminum. This silicon/aluminum oxide overcoat 58 can be written as SiₓAl₁₋ₓO_{1.5+x/2}, where “x” can vary from greater than 0 to less than 1.

Alternatively, overcoat 58 can be a multi-layer coating formed by separately formed layers of metal oxide materials, such as, but not limited to, a bilayer formed by one metal oxide-containing layer (e.g., a silica and/or alumina-containing first layer) formed over another metal oxide-containing layer (e.g., a silica and/or alumina-containing second layer). The individual layers of the multi-layer protective coating can be of any desired thickness.

Overcoat 58 can be of any desired thickness. In one non-limiting embodiment, overcoat 58 can be a silicon/aluminum oxide coating (SiₓAl₁₋ₓO_{1.5+x/2}) having a thickness in the range of 100-1,000 Å, such as 600-800 Å, or such as 700 Å.

### Interlayer

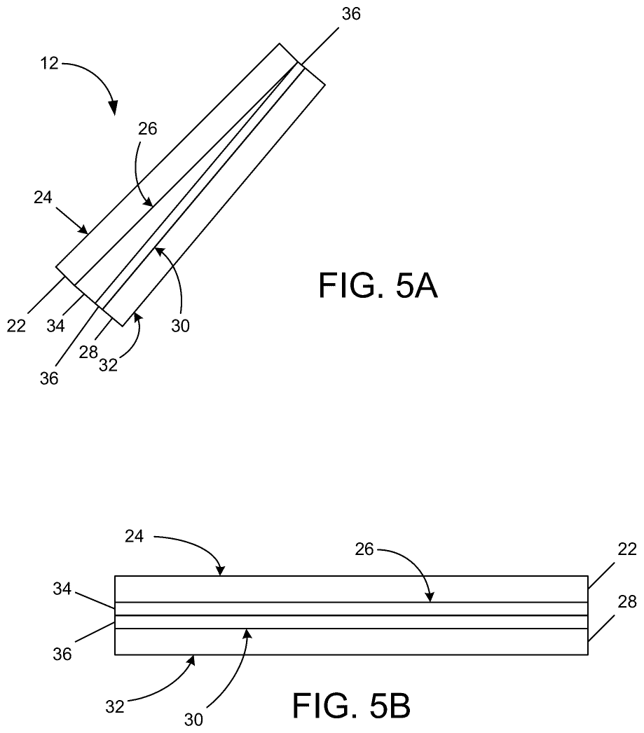

Referring to FIGS. 5A and 5B, laminate 12 can include interlayer 34. Interlayer 34 can be of a suitable material so as to hold plies 22 and 28 together. Interlayer 34 can be made of a polymer, such as polyvinyl butyral (PVB). Interlayer 34 can be positioned over second surface 26 and/or third surface 30. Interlayer 34 can be in contact with enhanced p-polarized reflective coating 36. Interlayer 34 can be of any suitable thickness to hold plies 22 and 28 together. Interlayer 34 can be a 0.76 mm thick interlayer 34 of PVB.

Referring to FIG. 5A, first ply 22 can be non-parallel relative to second ply 28. Interlayer 34 can be positioned between first ply 22 and second ply 28 and can be wedge-shaped. The wedge-shape of interlayer 34 can be configured such that radiation 16 reflects off of laminate 12 at the proper angle to avoid ghosting (e.g., to avoid seeing multiple images based on the direction of the light reflecting off of laminate 12 converging at different points).

Referring to FIG. 5B, interlayer 34 can be a layer of uniform thickness in other arrangements of laminate 12, as interlayer 34 might not need to be wedge-shaped to avoid the ghosting issue because other aspects of the design of laminate 12 counteract ghosting.

### Additional Coating Layers

As previously discussed, laminate 12 can include additional layers beyond enhanced p-polarized reflective coating 36. Laminate 12 can include anti-reflective coating 38. Anti-reflective coating 38 can be positioned over first surface 24 and/or fourth surface 32. The anti-reflective coating can comprise alternating layers of relatively high and low index of refraction materials. A “high” index of refraction material is any material having a higher index of refraction than that of the “low” index material. The low index of refraction material can be a material having an index of refraction of less than or equal to 1.75. Non-limiting examples of such materials include silica, alumina, and mixtures or combinations thereof. The high index of refraction material is a material having an index of refraction of greater than 1.75. Non-limiting examples of such materials include zirconia and zinc stannate. The anti-reflective coating can be, for example, a multi-layer coating having a first metal alloy oxide layer (first layer), a second metal oxide layer (second layer), a third metal alloy oxide layer (third layer), and a metal oxide top layer (fourth layer). In one non-limiting example, the fourth layer (upper low index layer) comprises silica or alumina or a mixture or combination thereof, the third layer (upper high index layer) comprises zinc stannate or zirconia or mixtures or combinations thereof, the second layer (bottom low index layer) comprises silica or alumina or a mixture or combination thereof, and the first layer (bottom high index layer) comprises zinc stannate or zirconia or mixtures or combinations thereof. Other suitable anti-reflective coatings are disclosed in U.S. Pat. No. 6,265,076 at column 2, line 53 to column 3, line 38; and Examples 1-3. Further suitable anti-reflective coatings are disclosed in U.S. Pat. No. 6,570,709 at column 2, line 64 to column 5, line 22; column 8, lines 12-30; column 10, line 65 to column 11, line 11; column 13, line 7 to column 14, line 46; column 16, lines 35-48; column 19, line 62 to column 21, line 4; Examples 1-13; and Tables 1-8.

Anti-reflective coating 38 can reduce the overall visible light reflectance and/or increase the visible light transmittance of enhanced p-polarized reflective coating 36. Materials having refractive indices around 2 are particularly useful for anti-reflective coating 38. It will be appreciated that applying an anti-reflective coating 38 over first surface 24 or fourth surface 32 can alter the Brewster's angle from the Brewster's angle of an air to glass interface or glass to air interface to the Brewster's angle of the air to anti-reflective coating material interface or the anti-reflective coating material to air interface. In this way, the amount of p-polarized radiation reflected and refracted can be altered compared to the case of the air to glass interface or the glass to air interface by including anti-reflective coating 38.

The display system laminate of the present invention can, in one instance, have in addition to the first coating described herein a second coating as described herein, where such second coating is located on at least a portion of the second surface or the third surface and only has two metal functional layers or only three metal functional layers. In some embodiments, such second coating is provided as a solar control coating to any of the laminates disclosed herein. In embodiments with only two metal functions layers, the enhanced p-polarized reflective coating can have the following ranges of thicknesses for each layer as detailed in Table 1.

TABLE 1

| | | Preferred | More Preferred | Most Preferred |
|---|---|---|---|---|
| Layer | Thickness (Å) | Thickness (Å) | Thickness (Å) | Thickness (Å) |
| Base Layer | 300-500 | 350-475 | 375-450 | 383-427 |
| 1^{st} Metal | 10-200 | 50-175 | 60-150 | 66-142 |
| 1^{st} Phase Adjustment | 700-1400 | 850-1300 | 875-1200 | 879-1048 |
| 2^{nd} Metal | 10-200 | 25-175 | 50-150 | 65-124 |
| Topcoat | 200-600 | 250-550 | 300-500 | 346-368 |
| Overcoat | 100-1000 | 250-900 | 400-800 | 650-750 |
| Total Thickness | 1320-3900 | 1775-3575 | 2060-3250 | 2389-2859 |
| Total Metal Thickness | 20-400 | 75-350 | 110-300 | 131-266 |

As to the embodiments of Table 1 above, although not listed therein, one or more primer layers can independently be formed over each of the first metal layer and/or the second metal layer. In the case where such one or more primer layers are present, each primer layer can have a thickness in the range of 10-50 Å, such as 20-40 Å, or even 25-35 Å.

In embodiments with only three metal functions layers, the enhanced p-polarized reflective coating can have the following ranges of thicknesses for each layer as detailed in Table 2.

TABLE 2

| | | Preferred | More Preferred | Most Preferred |
|---|---|---|---|---|
| Layer | Thickness (Å) | Thickness (Å) | Thickness (Å) | Thickness (Å) |
| Base Layer | 300-550 | 350-525 | 375-500 | 422-487 |
| 1^{st} Metal | 10-200 | 50-150 | 50-125 | 65-123 |
| 1^{st} Phase Adjustment | 600-1400 | 650-1250 | 675-1000 | 689-866 |
| 2^{nd} Metal | 10-150 | 50-125 | 65-75 | 67-74 |
| 2^{nd} Phase Adjustment | 300-1000 | 400-900 | 500-825 | 619-817 |
| 3^{rd} Metal | 50-200 | 55-175 | 60-150 | 65-135 |
| Topcoat | 200-600 | 250-550 | 300-500 | 311-411 |
| Overcoat | 100-1000 | 250-900 | 400-800 | 650-750 |
| Total Thickness | 1570-5100 | 2055-4575 | 2425-3975 | 2888-3663 |
| Total Metal Thickness | 70-550 | 155-450 | 175-350 | 197-332 |

As to the embodiments of Table 2 above, although not listed therein, one or more primer layers can independently be formed over each of the first metal layer, the second metal layer, and/or the third metal layer. In the case where such one or more primer layers are present, each primer layer can have a thickness in the range of 10-50 Å, such as 20-40 Å, or even 25-35 Å.

In embodiments with only four metal functions layers, the enhanced p-polarized reflective coating can have the following ranges of thicknesses for each layer as detailed in Table 3.

TABLE 3

| | | Preferred | More Preferred | Most Preferred |
|---|---|---|---|---|
| Layer | Thickness (Å) | Thickness (Å) | Thickness (Å) | Thickness (Å) |
| Base Layer | 300-550 | 350-525 | 375-500 | 422-487 |
| 1^{st} Metal | 10-200 | 50-150 | 50-125 | 65-123 |
| 1^{st} Phase Adjustment | 600-1400 | 650-1250 | 675-1000 | 689-866 |
| 2^{nd} Metal | 10-150 | 50-125 | 65-75 | 67-74 |
| 2^{nd} Phase Adjustment | 300-1000 | 400-900 | 500-825 | 619-817 |
| 3^{rd} Metal | 50-200 | 55-175 | 60-150 | 65-135 |
| 3^{rd} Phase Adjustment | 300-1000 | 400-900 | 500-825 | 619-817 |
| 4^{th} Metal | 10-200 | 50-150 | 50-125 | 65-123 |
| Topcoat | 200-600 | 250-550 | 300-500 | 311-411 |
| Overcoat | 100-1000 | 250-900 | 400-800 | 650-750 |
| Total Thickness | 1880-6300 | 2505-5625 | 2975-4925 | 2888-4603 |
| Total Metal Thickness | 80-750 | 205-600 | 225-475 | 262-455 |

As to the embodiments of Table 3 above, although not listed therein, one or more primer layers can independently be formed over each of the first metal layer, the second metal layer, and/or the third metal layer. In the case where such one or more primer layers are present, each primer layer can have a thickness in the range of 10-50 Å, such as 20-40 Å, or even 25-35 Å.

### Brewster's Angle

The Brewster's angle is defined as an angle of incidence at which p-polarized radiation is perfectly transmitted through the surface of laminate 12 contacted by the p-polarized radiation. In other words, the Brewster's angle is the angle of incidence at which all p-polarized radiation is refracted/transmitted such that no p-polarized radiation is reflected.

The Brewster's angle for an air to glass interface (such as when laminate 12 is glass) is approximately 57 degrees. The Brewster's angle for a glass to air interface (such as when laminate 12 is glass) is approximately 33 degrees. Thus, when the incidence angle of radiation 16 hitting fourth surface 32 of laminate 12 from radiation source 14 on an inner side of laminate 12 having an air to glass interface is 57 degrees, all p-polarized radiation is refracted and none is reflected off of fourth surface 32 to eye 20 of the user.

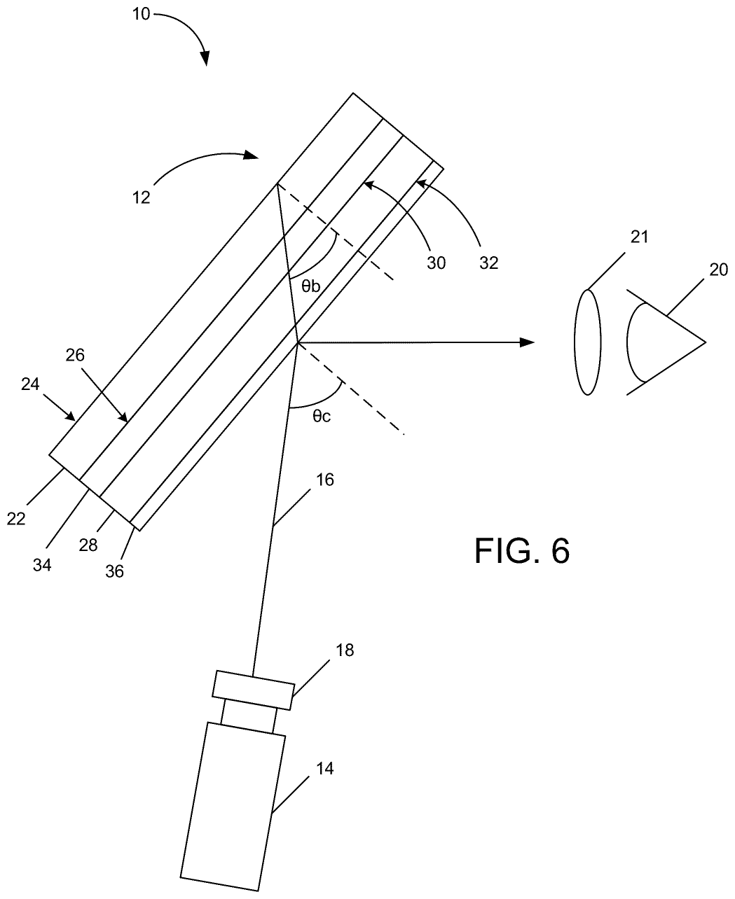

Referring to FIG. 6, the Brewster's angle of fourth surface 32 of system 10 can be altered by positioning enhanced p-polarized reflective coating 36 over first surface 24 or fourth surface 32. In FIG. 6, enhanced p-polarized reflective coating 36 is positioned over fourth surface 32. In this case, the Brewster's angle at fourth surface 32 becomes the Brewster's angle for the air to enhanced p-polarized reflective coating 36 interface.

With continued reference to FIG. 6, ghosting can be eliminated by positioning enhanced p-polarized reflective coating 36 on first surface 24 or fourth surface 32 by adjusting the angle at which radiation 16 hits enhanced p-polarized reflective coating 36. An example will be explained with enhanced p-polarized reflective coating 36 positioned over fourth surface 32, as shown in FIG. 6. Radiation 16 can contact enhanced p-polarized reflective coating 36 at a coating incidence angle θ_{c}. This coating incidence angle θ_{c} can be selected such that an incidence angle θ_{b} at first surface 24 is the Brewster's angle for the glass to air interface. In other words, coating incidence angle θ_{c} can be selected such that incidence angle θ_{b} is 33 degrees. In this scenario, p-polarized radiation reflects off of enhanced p-polarized reflective coating 36 at fourth surface 32 to eye 20 of the user but does not reflect off of first surface 24 to eye 20 of the user because all p-polarized radiation is refracted through at the Brewster's angle. If a polarized filter 18 is used to filter substantially all s-polarized radiation prior to reaching laminate 12, only p-polarized radiation reflected off of enhanced p-polarized reflective coating 36 at fourth surface 32 (as shown in FIG. 6) reaches eye 20 of the user, and ghosting is therefore reduced or eliminated. It will be appreciated that enhanced p-polarized reflective coating 36 can be positioned over first surface 24 and radiation 16 can be directed at laminate 12 such that radiation 16 contacts fourth surface 32 at the Brewster's angle of that air to glass interface (57 degrees) interface and contacts first surface 24 at an angle that is not the Brewster's angle of that glass to enhanced p-polarized reflective coating 36 interface.

### Test Configuration

Referring to FIG. 7, a test apparatus for which radiation 16 from radiation source 14 contacts laminate 12 at an angle of 60 degrees (or in some embodiments 70 degrees—not shown) relative to normal of laminate 12 is shown. In test apparatus of FIG. 7, radiation source 14 is positioned such that radiation 16 emitted therefrom contacts laminate 12 at an incident angle of 60 degrees relative to normal of laminate 12. Properties (reference laminated values) of laminate 12 and reflected radiation 16 can be measured from test apparatus of FIG. 7.

Using test apparatus of FIG. 7, laminate 12, including the previously described first ply 22, second ply 28, interlayer 34, and enhanced p-polarized reflective coating 36, can exhibit a luminous transmittance using standard illuminate A (LTA) of at least 70 percent, as measured according automotive industry standards. Using test apparatus of FIG. 7, laminate 12, including the previously described first ply 22, second ply 28, interlayer 34, and enhanced p-polarized reflective coating 36, can exhibit a reflectivity of the p-polarized radiation using D65 illuminate and a 10 degrees detector of at least 10 percent. Using test apparatus 86, laminate 12, including the previously described first ply 22, second ply 28, interlayer 34, and enhanced p-polarized reflective coating 36, can have a total reflectivity of up to 60 percent, such as up to 55 percent or up to 52 percent.

Regarding any numerical values disclosed in the specification (including any one or more numerical values from any one or more of the Tables contained herein), be they individual values in one or more examples, or from one or more portions of a numerical range, any of these individual numerical values can be combined with any other numerical value of a similar nature to form a new and/or non-disclosed range. That is, for example, any individual base layer thickness value can be combined with any other different base layer thickness value to yield a new non-disclosed base layer thickness numerical range. Further, any individual numerical value from a given layer component, a given layer thickness, or even a given single layer thickness value can be combined with any other different respective numerical value from a given layer component, a given layer thickness, or even a given single layer thickness to yield a new non-disclosed numerical range for one or more of any layer thickness values disclosed herein.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A laminate having enhanced p-polarized radiation reflecting properties comprising:
a first ply comprising a first surface and a second surface opposite the first surface, wherein the first surface comprises an outer surface of the laminate;
a second ply comprising a third surface adjacent the second surface and a fourth surface opposite the third surface, wherein the fourth surface comprises an inner surface of the laminate;
an interlayer positioned between the first ply and the second ply; and
a first coating positioned over at least a portion of the fourth surface, wherein the first coating comprises:
a first low refractive index layer positioned over at least a portion of the fourth surface of the second ply;
a first medium refractive index layer positioned over at least a portion of the first low refractive index layer;
a second low refractive index layer positioned over at least a portion of the first medium refractive index layer; and
a first high refractive index layer positioned over at least a portion of the second low refractive index layer,
wherein the laminate has a p-polarized reflection, as determined at an angle of 60 degrees relative to the normal of the laminate, of at least 10 percent of the p-polarized radiation at one or more wavelengths of at least 450 nm, 530 nm, and/or 620 nm.

2. The laminate of claim 1, wherein the laminate further comprises a second coating positioned over at least a portion of the second surface or the third surface, and wherein the second coating comprises:
a first dielectric layer positioned over the portion of the at least one of the second surface and/or the third surface;
a first metal layer positioned over at least a portion of the first dielectric layer;
a first primer layer positioned over at least a portion of the first metal functional layer;
a second dielectric layer positioned over at least a portion of the first primer layer;
a second metal layer positioned over at least a portion of the second dielectric layer;
a second primer layer positioned over at least a portion of the second metal functional layer; and
a third dielectric layer positioned over at least a portion of the second primer layer.

3. The laminate of claim 1, wherein the first coating further comprises a second medium refractive index layer positioned between at least a portion of the fourth surface of the second ply and the first low refractive index layer.

4. The laminate of claim 3, wherein the first coating further comprises a third low refractive index layer positioned over at least a portion of the first high refractive index layer.

5. The laminate of claim 3, wherein the first coating further comprises either a third medium refractive index layer positioned over at least a portion of the third low refractive index layer or a second high refractive index layer positioned over at least a portion of the third low refractive index layer.

6. The laminate of claim 5, wherein the first coating further comprises a protective layer over at least a portion of the third medium refractive index or a protective layer over at least a portion of the second high refractive index.

7. The laminate of claim 5, wherein the first low refractive index layer, the second low refractive layer and/or the third low refractive layer comprise a refractive index of 1.4 to 1.6.

8. The laminate of claim 5, wherein the first medium refractive index layer, the second medium refractive layer, and/or the third medium refractive index layer individually comprises a refractive index of 1.61 to 1.9.

9. The laminate of claim 5, wherein the first high refractive index and/or the second high refractive index layer individually comprises a refractive index of 1.91 to 2.2.

10. The laminate of claim 1, wherein the laminate is free from a polyvinyl butyral (PVB) wedge layer.

11. The laminate of claim 1, wherein the laminate has an LTA of at least 70 percent.

12. The laminate of claim 1, wherein when the laminate is applied to one side of a glass substrate the RfY, the percent reflection of visible light from the unlaminated glass side, is within ±1.5 percent of the RfY, the percent reflection of visible light from the laminate side.

13. A display system for projecting an image comprising the laminate of claim 1.

14. A laminate having enhanced p-polarized radiation reflecting properties comprising:
a first ply comprising a first surface and a second surface opposite the first surface, wherein the first surface comprises an outer surface of the laminate;
a second ply comprising a third surface adjacent the second surface and a fourth surface opposite the third surface, wherein the fourth surface comprises an inner surface of the laminate;
an interlayer positioned between the first ply and the second ply; and
a first coating positioned over at least a portion of the fourth surface, wherein the first coating comprises:
a first high refractive index layer positioned over at least a portion of the fourth surface of the second ply;
a first low refractive index layer positioned over at least a portion of the first high refractive index layer;
a second high refractive index layer positioned over at least a portion of the first low refractive index layer; and
a second low refractive index layer positioned over at least a portion of the second high refractive index layer,
wherein the laminate has a p-polarized reflection, as determined at an angle of 70 degrees relative to the normal of the laminate, of at least 37 percent of the p-polarized radiation at one or more wavelengths of at least 450 nm, 530 nm, and/or 620 nm.

15. The laminate of claim 14, wherein the laminate has a maximum reflectance of unpolarized light as determined at an angle of 70 degrees relative to the normal of the laminate of less than 28 percent at at least a wavelength of 550 nm.

16. The laminate of claim 14, wherein the first high refractive index layer is formed from any suitable material that comprises a refractive index of 1.91 to 2.2.

17. The laminate of claim 14, wherein the first low refractive index layer is formed from any suitable material that comprises a refractive index of 1.4 to 1.6.

18. The laminate of claim 14, wherein the second high refractive index layer is formed from any suitable material that comprises a refractive index of 1.91 to 4.

19. The laminate of claim 14, wherein the second low refractive index layer is formed from any suitable material that comprises a refractive index of 1.4 to 1.6.

20. The laminate of claim 14, wherein the laminate further comprises one or more of a protective layer, a topcoat layer, and/or an overcoat layer as described herein, where such one or more layers are all located on top of and above the second low refractive index layer.
